(19) United States
(12) Patent Application Publication
(10) Pub. No.: US 2022/0174576 A1
(43) Pub. Date: Jun. 2, 2022

(54) WIRELESS COMMUNICATION SYSTEM, WIRELESS COMMUNICATION METHOD, CONTROL DEVICE, CONTROL METHOD, AND NON-TRANSITORY COMPUTER-READABLE MEDIUM

(71) Applicant: NEC Corporation, Minato-ku, Tokyo (JP)

(72) Inventors: Daisuke OHTA, Tokyo (JP); Takahiro SHIROSHIMA, Tokyo (JP); Yuki HATASHI, Tokyo (JP); Jun SUZUKI, Tokyo (JP); Youichi HIDAKA, Tokyo (JP)

(73) Assignee: NEC Corporation, Minato-ku, Tokyo (JP)

(21) Appl. No.: 17/442,813

(22) PCT Filed: Dec. 26, 2019
(86) PCT No.: PCT/JP2019/051067

§ 371 Date: Sep. 24, 2021

(30) Foreign Application Priority Data
Mar. 28, 2019 (JP) 2019-063951

(51) Int. Cl. H04W 40/02; H04W 24/08

(52) U.S. Cl. CPC H04W 40/02; H04W 24/08

(57) ABSTRACT

A wireless communication system according to the present invention includes a transmission control device and a reception control device configured to communicate with each other via at least one wireless link established in a wireless network, the transmission control device including a composite signal generation unit configured to select at least one signal from a predetermined number of signals to generate a composite signal and a multipath control unit configured to transmit the composite signal via the at least one wireless link, the reception control device including a multipath control unit configured to receive the composite signal from the at least one wireless link and a signal recovery unit configured to accumulate the received composite signal and to recover the predetermined number of signals from the predetermined number or more of the composite signals, the predetermined number being 1 or more.

### TECHNICAL FIELD

The present invention relates to a wireless communication system, a wireless communication method, a control device, a control method, and a non-transitory computer-readable medium.

### BACKGROUND ART

An IoT (Internet of Things), which uses a network constructed in a wireless manner, has been known. The network constructed in a wireless manner is prone to delays and has poor communication characteristics as compared with a network constructed in a wired manner. Therefore, the network constructed in a wireless manner is preferably configured such that an arrival of a signal transmitted from a transmission terminal to a reception terminal can be guaranteed.

In a technique disclosed in Non Patent Literature 1, the arrival of a signal transmitted from the transmission terminal to the reception terminal is guaranteed by an automatic repeat request (ARQ) scheme. In the ARQ scheme, data is added with a sequence number indicating a sequence, and thus when a data loss is detected in the reception terminal, retransmission is required for the transmission terminal.

### CITATION LIST

### Non Patent Literature

Non Patent Literature 1: G. Fairhurst, L. Wood, “Advice to link designers on link Automatic Repeat request (ARQ)”, RFC 3366, August 2002

### SUMMARY OF INVENTION

### Technical Problem

In the ARQ scheme, acknowledgement confirmation (positive acknowledgement; ACK and negative-acknowledgement; NACK) need to be performed for each transmission. Therefore, when a data loss is detected in the reception terminal, a round trip occurs between the transmission terminal and the reception terminal. A timeout constraint is usually provided in manufacturing devices and IT devices used at manufacturing sites such as factories to detect physical malfunction of the devices. For this reason, it is necessary to prevent an occurrence of delay in real time control. However, according to the ARQ scheme, when retransmissions occur several times, the number of round trips increases and a delay occurs. Therefore, according to the ARQ scheme, when retransmissions occur several times, the timeout constraint may not be satisfied.

Further, according to the ARQ scheme, since it is necessary to control an arrival sequence of signals, a large-capacity buffer is generally required. However, devices such as input/output devices installed at manufacturing sites draws a buffer from a limited internal memory. Therefore, it is difficult to provide a large-capacity buffer in the devices such as input/output devices.

The present invention has been made in view of such problems, and is to provide a wireless communication system, a wireless communication method, a transmission control device, a reception control device, a transmission control program, and a reception control program capable of reducing the number of round trips and realizing a low delay without requiring a large-capacity buffer.

### Solution to Problem

A wireless communication system according to an aspect of the present invention includes:

a transmission control device and a reception control device configured to communicate with each other via at least one wireless link established in a wireless network,

the transmission control device including a composite signal generation unit configured to select at least one signal from a predetermined number of signals to generate a composite signal, and a multipath control unit configured to transmit the composite signal via the at least one wireless link,

the reception control device including a multipath control unit configured to receive the composite signal from the at least one wireless link, and a signal recovery unit configured to accumulate the received composite signal and to recover the predetermined number of signals from the predetermined number or more of the composite signals, and

the predetermined number being 1 or more.

A transmission control device according to an aspect of the present invention includes:

a composite signal generation unit configured to select at least one signal from a predetermined number of signals to generate a composite signal; and

a multipath control unit configured to transmit the composite signal via at least one wireless link established in a wireless network.

A reception control device according to an aspect of the present invention includes:

a multipath control unit configured to receive a composite signal from at least one wireless link established in a wireless network;

a signal recovery unit configured to accumulate the received composite signal and to recover the predetermined number of signals from the predetermined number or more of the composite signals,

the predetermined number being 1 or more.

A wireless communication system according to an aspect of the present invention includes:

two transmission/reception control devices configured to communicate with each other via at least one wireless link established in a wireless network,

each of the two transmission/reception control devices including:

a composite signal generation unit configured to select at least one signal from a predetermined number of signals to generate a composite signal;

a multipath control unit configured to transmit the composite signal via the at least one wireless link and to receive a composite signal transmitted from a communication partner via the at least one wireless link; and

a signal recovery unit configured to accumulate the received composite signal and to recover the predetermined number of signals from the predetermined number or more of the composite signals,

the predetermined number being 1 or more.

A wireless communication system according to an aspect of the present invention includes:

a step of selecting at least one signal from a predetermined number of signals to generate a composite signal in a composite signal generation unit of a transmission control device;

a step of transmitting the composite signal to a reception control device via at least one wireless link established in a wireless network in a multipath control unit of the transmission control device;

a step of receiving the composite signal from the at least one wireless link in a multipath control unit of the reception control device; and

a step of recovering the predetermined number of signals from the received composite signal in a signal recovery unit of the reception control device.

A transmission control program according to an aspect of the present invention causes a computer to execute;

a process of selecting at least one signal from a predetermined number of signals to generate a composite signal; and

a process of transmitting the composite signal via at least one wireless link established in a wireless network such that the reception control device is capable of receiving the composite signal.

A reception control program according to an aspect of the present invention causes a computer to execute:

a process of receiving a composite signal transmitted from a transmission control device via at least one wireless link established in a wireless network; and

a process of recovering a predetermined number of signals from the received composite signal.

### Advantageous Effects of Invention

According to the present invention, it is possible to provide a wireless communication system, a wireless communication method, a transmission control device, a reception control device, a transmission control program, and a reception control program capable of reducing the number of round trips and realizing a low delay without requiring a large-capacity buffer.

### BRIEF DESCRIPTION OF DRAWINGS

FIG. 1 is a block diagram showing a configuration of a wireless communication system according to a first example embodiment.

FIG. 2 is a block diagram showing a configuration of a wireless communication system according to a second example embodiment.

FIG. 3 is a flowchart illustrating an example of an operation in an encoding process of a transmission control device according to the second example embodiment.

FIG. 4 is a flowchart illustrating an example of an operation in an encoding process of a reception control device according to the second example embodiment.

FIG. 5 is a flowchart illustrating an example of an operation in a coded packet transmitting process of the transmission control device according to the second example embodiment.

FIG. 6 is a flowchart illustrating an example of an operation in a decoding process of the reception control device according to the second example embodiment.

FIG. 7 is a flowchart illustrating an example of an operation in a signal transmitting process of the reception control device according to the second example embodiment.

FIG. 8 is a block diagram showing a configuration of one modification of the wireless communication system according to the second example embodiment.

FIG. 9 is a block diagram showing a configuration of another modification of the wireless communication system according to the second example embodiment.

FIG. 10 is a block diagram showing a configuration of further another modification of the wireless communication system according to the second example embodiment.

FIG. 11 is a block diagram showing a configuration of a wireless communication system according to a third example embodiment.

FIG. 12 is a flowchart illustrating an example of an operation in a signal transmitting process of a transmission/reception control device according to the third example embodiment.

FIG. 13 is a block diagram showing a configuration of one modification of the wireless communication system according to the third example embodiment.

FIG. 14 is a block diagram showing a configuration of another modification of the wireless communication system according to the third example embodiment.

FIG. 15 is a block diagram showing a configuration of further another modification of the wireless communication system according to the third example embodiment.

FIG. 16 is a block diagram showing a configuration of a wireless communication system according to a fourth example embodiment.

FIG. 17 is a flowchart illustrating an example of an operation in an encoding process of a transmission control device according to the fourth example embodiment.

FIG. 18 is a flowchart illustrating another example of the operation in the encoding process of the transmission control device according to the fourth example embodiment.

FIG. 19 is a flowchart illustrating an example of an operation in a signal transmitting process of a reception control device according to the fourth example embodiment.

FIG. 20 is a block diagram showing a configuration of a wireless communication system according to a fifth example embodiment.

### DESCRIPTION OF EMBODIMENT

Specific example embodiments of the present invention will be described in detail below with reference to the drawings. However, the present invention is not limited to example embodiments to be described below. Further, the following description and drawings are simplified as appropriate for the sake of clarity of description.

### First Example Embodiment

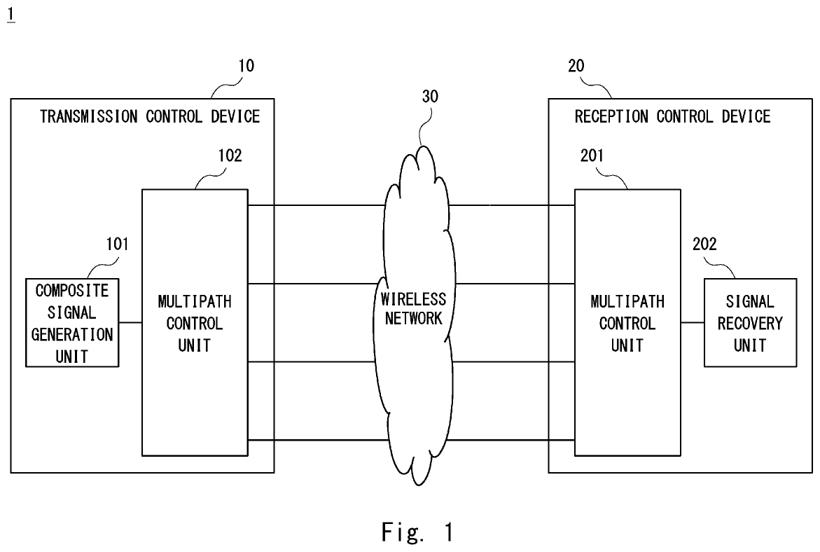

First, a configuration of a wireless communication system according to a first example embodiment will be described with reference to FIG. 1. FIG. 1 is a block diagram showing a configuration of the wireless communication system according to the first example embodiment. As shown in FIG. 1, a wireless communication system 1 includes a transmission control device 10 and a reception control device 20. The transmission control device 10 includes a composite signal generation unit 101 and a multipath control unit 102. The reception control device 20 includes a multipath control unit 201 and a signal recovery unit 202.

The transmission control device 10 and the reception control device 20 communicate with each other via at least one wireless link established in a wireless network 30. The composite signal generation unit 101 selects at least one signal from a predetermined number of K signals and generates composite signals. Here, the predetermined number of K is an integer of 1 or more. The multipath control unit 102 transmits the composite signals via at least one wireless link established in the wireless network 30 such that the reception control device 20 can receive the composite signals.

The multipath control unit 201 in the reception control device 20 receives the composite signals, which are sent from the multipath control unit 102 in the transmission control device 10, from at least one wireless link established in the wireless network 30. The signal recovery unit 202 accumulates the composite signals received by the multipath control unit 201, and recovers K signals from at least K composite signals.

A signal used for the transmission control device 10 and the reception control device 20 is a packet or a modulation signal. When the signal is a packet, the composite signal generation unit 101 encodes the signal. An encoding method performed by the composite signal generation unit 101 is not particularly limited. The composite signal generation unit 101 performs encoding due to, for example, rateless coding. In the encoding due to the rateless coding, at least one packet is selected from K packets to generate coded packets obtained by an exclusive OR (XOR).

When the signal is a modulation signal, the composite signal generation unit 101 multiplexes the signal. A multiplexing method performed by the composite signal generation unit 101 is not particularly limited. The composite signal generation unit 101 performs a non-orthogonal multiple access (NOMA), for example. In the non-orthogonal multiple access, at least one modulation signal is selected from K modulation signals, and each of the selected modulation signals is multiplexed by being applied with different transmission power.

The signal recovery unit 202 accumulates the composite signals received by the multipath control unit 201, and recovers K signals from at least K composite signals. A recovery method of the signal in the signal recovery unit 202 is not particularly limited. The signal recovery unit 202 recovers K signals from the composite signals received by the multipath control unit 102 of the reception control device 20, using Gaussian elimination, for example. With the Gaussian elimination, K signals can be recovered when there are at least K composite signals. Therefore, the signal recovery unit 202 needs to accumulate at least K signals from the composite signals received by the multipath control unit 201.

The wireless communication system 1 can transmit and receive the composite signal without performing acknowledgements of a NACK and an ACK for each transmission. Accordingly, it is not necessary to perform a NACK when the composite signal received by the reception control device 20 is being lost. In the wireless communication system 1, further, the reception control device 20 performs one ACK for the plurality of received signals. Therefore, the wireless communication system 1 can prevent a delay by preventing the number of round trips as compared with a communication system using an ARQ scheme.

In the wireless communication system 1, it is not necessary to control an arrival sequence of the composite signals. Therefore, a large-capacity buffer is not required to be provided in the wireless communication system 1. Accordingly, the wireless communication system 1 can reduce the number of round trips and can realize a low delay without requiring a large-capacity buffer.

As described above, according to the first example embodiment of the present invention, it is possible to reduce the number of round trips and to realize a low delay without requiring a large-capacity buffer.

### Second Example Embodiment

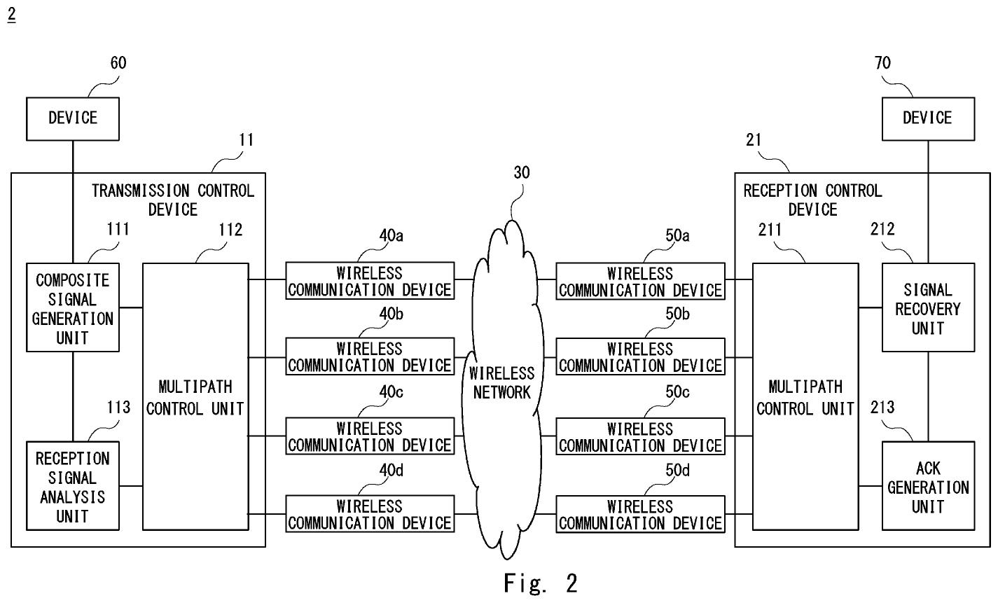

A second example embodiment of the present invention is a more specific example embodiment. First, a configuration of a wireless communication system according to the second example embodiment will be described with reference to FIG. 2. FIG. 2 is a block diagram showing a configuration of the wireless communication system according to the second example embodiment. As shown in FIG. 2, a wireless communication system 2 includes a transmission control device 11, a reception control device 21, wireless communication devices 40a to 40d, wireless communication devices 50a to 50d, a device 60, and a device 70.

The transmission control device 11 and the reception control device 21 communicate with each other via a plurality of wireless links established in a wireless network 30 and having different frequencies. A multipath control unit 112 in the transmission control device 11 selects at least one wireless link from a plurality of wireless links, and transmits composite signals such that the reception control device 21 can receive the composite signals. A multipath control unit 211 in the reception control device 21 receives the composite signals, which are transmitted from the multipath control unit 112 in the transmission control device 11, from a plurality of wireless links, respectively.

A method is not particularly limited in which the multipath control unit 112 selects at least one wireless link from the plurality of wireless links. The multipath control unit 112 may randomly select a wireless link from the plurality of wireless links. Further, the multipath control unit 112 may select at least one wireless link from the plurality of wireless links such that the number of transmissions to each of the plurality of wireless links is equal.

The multipath control unit 112 preferably selects at least one wireless link from the plurality of wireless links using communication characteristics to be guaranteed with respect to a delay time required for the composite signal to reach the reception control device 21 from the transmission control device 11 and a status of the wireless network 30. The communication characteristics to be guaranteed with respect to the delay time required for the composite signal to reach the reception control device 21 from the transmission control device 11 preferably include a maximum allowable delay value which is a maximum value allowable for the delay time and a guarantee probability of the maximum allowable delay value. The communication characteristics to be guaranteed with respect to the delay time required for the composite signal to reach the reception control device 21 from the transmission control device 11 further preferably satisfy the maximum allowable delay value and the guarantee probability.

In the wireless communication system 2, a signal used for communication is a packet. When the signal is a packet, examples of characteristics of the wireless network 30 to be measured include a forward transmission delay, a packet loss rate, a transmission band, and a packet size of the packet between the transmission control device 11 and the reception control device 21. Therefore, the multipath control unit 112 preferably selects a wireless link based on at least one of the forward transmission delay, the packet loss rate, the transmission band, and the packet size of the packet between the transmission control device 11 and the reception control device 21.

The transmission control device 11 is connected to the wireless communication device 40a, the wireless communication device 40, the wireless communication device 40c, the wireless communication device 40d, and the device 60. The reception control device 21 is connected to the wireless communication device 50a, the wireless communication device 50b, the wireless communication device 50c, the wireless communication device 50d, and the device 70. The wireless communication device 40a is connected to the wireless communication device 50a via the wireless network 30. The wireless communication device 40b is connected to the wireless communication device 50b via the wireless network 30. The wireless communication device 40c is connected to the wireless communication device 50c via the wireless network 30. The wireless communication device 40d is connected to the wireless communication device 50d via the wireless network 30.

In the following description, the wireless communication devices 40a to 40d connected to the transmission control device 11 are referred to as a “wireless communication device 40” at the time of description of a common item. In addition, the wireless communication devices 50a to 50d connected to the reception control device 21 are referred to as a “wireless communication device 50” at the time of description of a common item.

The wireless communication system 2 includes two or more wireless communication devices 40 and two or more wireless communication devices 50. In the wireless communication system 2, the number of wireless communication devices 40 is equal to the number of wireless communication devices 50. For example, as shown in FIG. 2, the wireless communication system 2 includes four wireless communication devices 40 and four wireless communication devices 50. However, the wireless communication system 2 may include two wireless communication devices 40 and two wireless communication devices 50, for example.

The wireless communication system 2 includes one device 60 and one device 70. For example, as shown in FIG. 2, the wireless communication system 2 includes one device 60 and one device 70. However, the wireless communication system 2 may include a plurality of devices 60 and a plurality of devices 70. The wireless communication system 2 may include a plurality of devices 60 and one device 70.

The transmission control device 11 and the reception control device 21 communicate with each other via the plurality of wireless link having different frequencies established in the wireless network 30. In the example shown in FIG. 2, four wireless links are established. The four wireless links are established between the wireless communication device 40a and the wireless communication device 50a, between the wireless communication device 40b and the wireless communication device 50b, between the wireless communication device 40c and the wireless communication device 50c, and between the wireless communication device 40d and the wireless communication device 50d, respectively.

The transmission control device 11 and the wireless communication device 40 can communicate with each other via a communication line network (NW). The transmission control device 11 and the device 60 can communicate with each other via a communication line network. The reception control device 21 and the wireless communication device 50 can communicate with each other via a communication line network. The reception control device 21 and the device 70 can communicate with each other via a communication line network. The communication line network is a local area network (LAN), for example. However, the communication line network can use a known network without being particularly limited. The communication line network is a personal area network (PAN) or a CAN (Campus Area Network), for example. The communication line network may be a metropolitan area network (MAN), a wide area network (WAN), or a GAN (Global Area Network). The communication line network may be an external network such as the Internet.

The communication may be performed between the transmission control device 11 and the wireless communication device 40, between the transmission control device 11 and the device 60, between the reception control device 21 and the wireless communication device 50, and between the reception control device 21 and the device 70 via an interface instead of the communication line network. The interface is, for example, an RS (Recommended Standard)-232 or an RS-422, an RS-485, a USB (universal serial bus), and an IEEE 1394.

The transmission control device 11 includes an information processor and a communication interface which are not shown. The information processor includes a central processing unit (CPU) and a storage unit which are not shown. The storage unit in the information processor is a memory and a hard disk drive (HDD). The transmission control device 11 is configured to realize a function to be described below by executing a program stored in the storage unit with the central processing unit, for example. The transmission control device 11 may be an IP core (intellectual property core). The IP core is, for example, an FPGA (field-programmable gate array), an IC (Integrated Circuit), and an LSI (Large Scale Integration).

The reception control device 21 includes an information processor and a communication interface which are not shown. The information processor includes a central processing unit and a storage unit which are not shown. The storage unit in the information processor is a memory and a hard disk drive. The reception control device 21 is configured to realize a function to be described below by executing a program stored in the storage unit with the central processing unit, for example. The reception control device 21 may be an IP core.

Each of the wireless communication devices 40 and 50 is a wireless communication station. Each of the wireless communication devices 40 and 50 is a wireless communication station of a wireless LAN router, for example. Each of the wireless communication devices 40 and 50 may be a wireless communication station such as a base station. Each of the wireless communication devices 40 and 50 includes an information processor and a communication interface which are not shown. Further, each of the wireless communication devices 40 and 50 includes a central processing unit and a storage unit which are not shown. Each of the wireless communication devices 40 and 50 is configured to realize a function, which is provided in the wireless communication device of a general communication system, by executing a program stored in the storage unit with the central processing unit.

In the wireless communication system 2, the plurality of wireless links established in the wireless network 30 may be used as long as having different frequencies, respectively. The wireless communication devices 40 and 50 may be used as long as being capable of communicating with each other at respective frequencies of the plurality of wireless links.

For example, as shown in FIG. 2, the wireless communication device 40a and the wireless communication device 50a are wireless LAN routers conforming to IEEE 802.11g. The IEEE 802.11g is one of wireless LAN (Local Area Network)-related standards defined by IEEE (The Institute of Electrical and Electronics Engineers, Inc.). The wireless link established via the wireless communication device 40a and the wireless communication device 50a is established in a frequency band of 2.4 GHz. The wireless communication device 40b and the wireless communication device 50b are wireless LAN routers conforming to IEEE 802.11a which is one of wireless LAN-related standards defined by the IEEE. The wireless link established via the wireless communication device 40b and the wireless communication device 50b is established in a frequency band of 5.2 GHz.

The wireless communication device 40c and the wireless communication device 50c are wireless LAN routers conforming to IEEE 802.11ac which is one of wireless LAN-related standards defined by the IEEE. The wireless link established via the wireless communication device 40c and the wireless communication device 50c is established in a frequency band of 5.6 GHz. The wireless communication device 40d and the wireless communication device 50d are wireless LAN routers conforming to IEEE 802.11ad which is one of wireless LAN-related standards defined by the IEEE. The wireless link established via the wireless communication device 40d and the wireless communication device 50d is established in a frequency band of 60 GHz.

In the example shown in FIG. 2, different wireless standards are used for each of the plurality of wireless links established in the wireless network 30. However, the same wireless standard may be used for all of the plurality of wireless links. When the same wireless standard is used, channels with different frequencies are used among the plurality of wireless links. For example, when all of the plurality of wireless links use the IEEE 802.11g, 1 ch, 5 ch, 9 ch, 13 ch are assigned to each of the plurality of wireless links from 13 channels included in the IEEE 802.11g, that is, 1 ch to 13 ch.

The device 60 has a communication function. The device 60 is, for example, an IT device such as a server or a workstation, a personal computer, a sensor, or a manufacturing device. The device 60 may be a mobile phone terminal, a PHS (Personal Handyphone System) terminal, or a PDA (Personal Data Assistance, Personal Digital Assistant), for example. The device 60 may be, for example, a smartphone, a tablet terminal, a car navigation terminal, or a game terminal. The device 60 includes a central processing unit and a storage unit which are not shown. The device 60 may include an information processor, a transceiver, an input device, and an output device which are not shown. The transceiver includes a transmitter and a receiver. The input device includes key buttons and a microphone. The output device includes a display and a speaker.

The device 60 is configured to realize a function of generating a signal to be transmitted to the device 70 by executing a program stored in the storage unit with the central processing unit. In the example shown in FIG. 2, the device 60 generates a signal to be transmitted to the device 70. The generated signal is transmitted to the transmission control device 11 via the communication line network.

The device 60 is also configured to realize a function provided in a general device by executing a program stored in the storage unit with the central processing unit. The general device is, for example, an IT device such as a server or a workstation, a personal computer, various sensors, a manufacturing device, or a mobile phone terminal. The function provided in the general device is, for example, a function of generating control command information for controlling the device 70 or a function of generating peripheral environment information necessary for the device 70 to control.

The device 70 has a communication function. The device 60 is, for example, an IT device such as a server or a workstation, a personal computer, a sensor, or a manufacturing device, a mobile phone terminal, a PHS terminal, a PDA, a smartphone, a tablet terminal, a car navigation terminal, or a game terminal. The device 70 includes a central processing unit and a storage unit which are not shown. The device 60 may include an information processor, a transceiver, an input device, and an output device which are not shown. The transceiver includes a transmitter and a receiver. The input device includes key buttons and a microphone. The output device includes a display and a speaker.

The device 70 is configured to realize a function of receiving the signal generated by the device 60 for transmission to the device 70 by executing a program stored in the storage unit with the central processing unit.

The device 70 is also configured to realize a function provided in the general device by executing a program stored in the storage unit with the central processing unit. The general device is, for example, an IT device such as a server or a workstation, a personal computer, various sensors, a manufacturing device, and a mobile phone terminal. The function provided in the general device is, for example, a function of controlling according to the control command information notified from the device 60 and a function of controlling using the peripheral environment information notified from the device 60.

The transmission control device 11 includes a composite signal generation unit 111, a multipath control unit 112, and a reception signal analysis unit 113. Operations of the composite signal generation unit 111, the multipath control unit 112, and the reception signal analysis unit 113 will be described below when the central processing unit, the transceiver, and the storage unit provided in the transmission control device 11 operate in cooperation with each other.

The composite signal generation unit 111 can accumulate the signals transmitted from the device 60. The composite signal generation unit 111 can select K signals from the accumulated signals to generate a composite signal from the selected K signals. When the signal is a packet, the composite signal generation unit 111 selects K packets from the accumulated packets to generate coded packets from the selected K packets. The coded packet is generated by an encoding process due to rateless coding, for example. In the encoding process due to the rateless coding, at least one packet is selected from K packets to generate a coding packet obtained by an exclusive OR (XOR).

In the second example embodiment, a case will be described below in which the encoding process due to the rateless coding is performed. In the second example embodiment, a predetermined number K is set in the transmission control device 11. However, the predetermined number K may be set in the device 60, the device 70, the reception control device 21, the wireless communication device 40, or the wireless communication device 50. When the predetermined number K is set in the device 60, the device 70, the reception control device 21, the wireless communication device 40, or the wireless communication device 50, the device used to set the predetermined number K notifies the transmission control device 11 of information related to the predetermined number K. The transmission control device 11 sets the predetermined number K based on the notified information.

The coded packet generated by the composite signal generation unit 111 is transmitted to the multipath control unit 112. Although the details will be described, the encoding process due to the rateless coding is repeated until an ACK notification is received from the reception signal analysis unit 113. When the composite signal generation unit 111 receives the ACK notification from the reception signal analysis unit 113, the encoding process is ended, and the K packets targeted for the encoding process are discarded.

The multipath control unit 112 establishes a plurality of wireless links having different frequencies in the wireless network 30 to enable communication between the transmission control device 11 and the reception control device 21. The multipath control unit 112 selects at least one wireless link from the plurality of wireless links having different frequencies established in the wireless network 30, and transmits the coded packet transmitted from the composite signal generation unit 111 to the reception control device 21. The coded packet transmitted from the multipath control unit 112 is transmitted from the wireless communication device 40 on the selected wireless link. The transmitted coded packet is received by the wireless communication device 50 on the same wireless link, and arrives at the multipath control unit 211.

Although the details will be described below, the multipath control unit 112 receives ACK packets from the plurality of wireless links having different frequencies established between the transmission control device 11 and the reception control device 21. The ACK packets received by the multipath control unit 112 are generated by an ACK generation unit 213 included in the reception control device 21. The received ACK packets are transmitted to the reception signal analysis unit 113. The reception signal analysis unit 113 notifies the composite signal generation unit 111 of ACK when the ACK packets generated by the ACK generation unit 213 arrive.

The reception control device 21 includes a multipath control unit 211, a signal recovery unit 212, and an ACK generation unit 213. Operations of the multipath control unit 211, the signal recovery unit 212, and the ACK generation unit 213 will be described below when the central processing unit, the transceiver, and the storage unit provided in the reception control device 21 operate in cooperation with one another.

The multipath control unit 211 establishes a plurality of wireless links having different frequencies in the wireless network 30 to enable communication between the transmission control device 11 and the reception control device 21. The multipath control unit 211 receives the coded packets from the plurality of wireless links having different frequencies established in the wireless network 30. The coded packets received by the multipath control unit 211 are transmitted to the signal recovery unit 212.

Although the details will be described below, the multipath control unit 211 selects at least one wireless link from the plurality of wireless links having different frequencies established between the transmission control device 11 and the reception control device 21, and transmits an ACK packet to the transmission control device 11. The ACK packet transmitted by the multipath control unit 211 is generated by the ACK generation unit 213. The ACK packet transmitted by the multipath control unit 211 is transmitted from the wireless communication device 50 on the selected wireless link. The transmitted ACK packet is received by the wireless communication device 40 on the same wireless link, and arrives at the transmission control device 11.

The signal recovery unit 212 accumulates the coded packets transmitted by the multipath control unit 211. The signal recovery unit 212 decodes the accumulated coded packets and decodes K packets. A recovery method of the signal in the signal recovery unit 212 is not particularly limited. The signal recovery unit 212 recovers K packets from the accumulated coded packet, using Gaussian elimination, for example. With the Gaussian elimination, K packets can be recovered when there are at least K coded packets. Therefore, the signal recovery unit 212 needs to accumulate at least K coded packets transmitted by the multipath control unit 211.

The decoded K packets are sent to the device 70. When the decoding of the packets is completed, the signal recovery unit 212 notifies the ACK generation unit 213 that the decoding of the packets is completed. Upon receiving the notification from the signal recovery unit 212 that the decoding of K packets is completed, the ACK generation unit 213 generates an ACK packet. The generated ACK packet is transmitted from the multipath control unit 211 to the transmission control device 11.

### <Description of Operation>

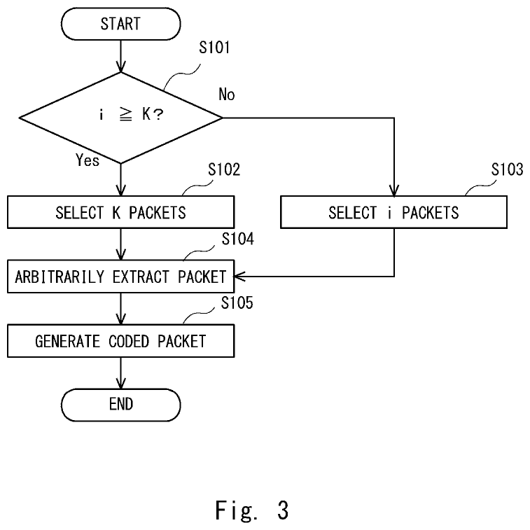

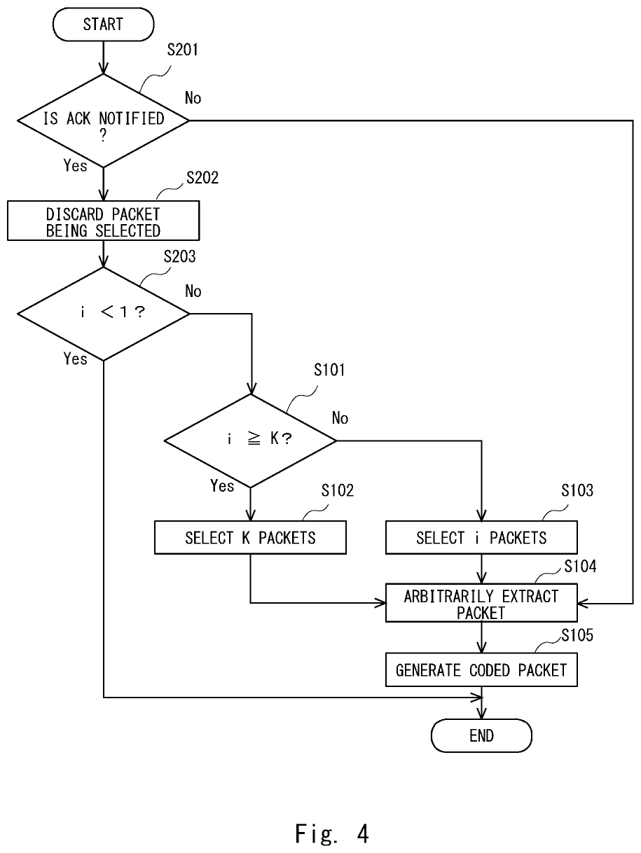

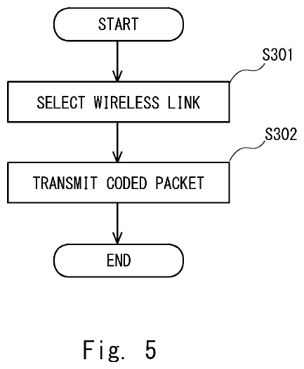

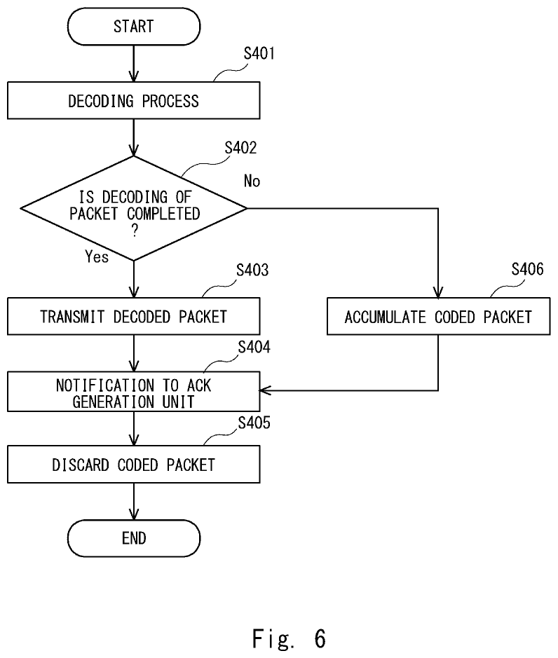

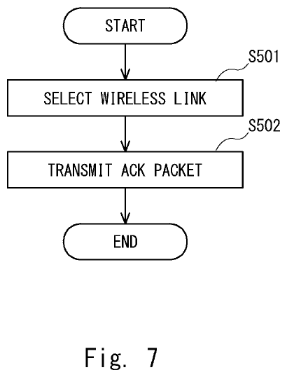

An operation of the wireless communication system according to the second example embodiment will be described in detail below with reference to FIGS. 3 to 7. FIG. 3 is a flowchart illustrating an example of an operation in the encoding process of the transmission control device according to the second example embodiment. FIG. 4 is a flowchart illustrating an example of an operation in the encoding process of the reception control device according to the second example embodiment. FIG. 5 is a flowchart illustrating an example of an operation in the coded packet transmitting process of the transmission control device according to the second example embodiment. FIG. 6 is a flowchart illustrating an example of an operation in the decoding process of the reception control device according to the second example embodiment. FIG. 7 is a flowchart illustrating an example of an operation in the signal transmitting process of the reception control device according to the second example embodiment.

FIG. 3 shows an operation procedure in which the composite signal generation unit 111 included in the transmission control device 11 selects K packets from the accumulated packets, codes the selected K packets, and generates coded packets. The transmission control device 11 executes the operation shown in FIG. 3 when the number of packets accumulated in the composite signal generation unit 111 changes from 0 to 1.

First, the composite signal generation unit 111 included in the transmission control device 11 determines whether the number i of packets accumulated in the composite signal generation unit 111 is a predetermined number K or more (step S101). In the second example embodiment, the predetermined number K is 5. However, the predetermined number K is not particularly limited as long as being an integer of 1 or more.

When the number i of packets accumulated in the composite signal generation unit 111 is the predetermined number K or more (step S101, YES), the composite signal generation unit 111 selects K packets from the i packets accumulated therein (step S102). In the second example embodiment, the K packets are selected in descending order from the longest accumulation time in the composite signal generation unit 111.

Next, the composite signal generation unit 111 arbitrarily extracts at least one packet from the packets selected in step S102 (step S104).

Subsequently, the composite signal generation unit 111 generates a coded packet in which the packet extracted in step S104 is subjected to exclusive OR (XOR) (step S105), and the operation is ended.

On the other hand, when the number i of packets accumulated in the composite signal generation unit 111 is less than the predetermined number K (step S101, NO), the composite signal generation unit 111 selects all of the i accumulated packets (step S103).

Next, the composite signal generation unit 111 arbitrarily extracts at least one packet from the packets selected in step S103 (step S104).

FIG. 4 shows an operation procedure in which the composite signal generation unit 111 included in the transmission control device 11 selects a predetermined number of K packets from the accumulated packets, codes the selected K packets, and generates coded packets. The transmission control device 11 executes the operation shown in FIG. 4 when the number of packets accumulated in the composite signal generation unit 111 is 1 or more.

In the operation shown in FIG. 4, processes of steps S201 to S203 are newly added to the operation shown in FIG. 3. Therefore, operations of added steps S201 to step S203 will be described below, and the duplicated description will be omitted.

First, the composite signal generation unit 111 included in the transmission control device 11 determines whether ACK is notified from the reception signal analysis unit 113 in the transmission control device 11 (step S201)

When the ACK is notified from the reception signal analysis unit 113 (step S201, YES), the composite signal generation unit 111 discards the packets selected in step S102 or step S103, from the accumulated packets (step S202).

Next, the composite signal generation unit 111 determines whether the number i of packets accumulated in the composite signal generation unit 111 is less than 1 (step S203)

When the number i of packets accumulated in the composite signal generation unit 111 is less than 1 (step S203, YES), it is determined that no packet is accumulated in the composite signal generation unit 111, and the operation is ended.

On the other hand, when the number i of packets accumulated in the composite signal generation unit 111 is 1 or more (step S203, NO), the composite signal generation unit 111 determines whether the number i of packets accumulated in the composite signal generation unit 111 is the predetermined number K or more (step S101).

Further, when the ACK is not notified from the reception signal analysis unit 113 (step S201, NO), the composite signal generation unit 111 arbitrarily extracts at least one packet from the packets selected in step S102 or step S103 (step S104).

FIG. 5 shows an operation procedure in which the multipath control unit 112 included in the transmission control device 11 selects at least one wireless link from a plurality of wireless links having different frequencies and the coded packet sent from the composite signal generation unit 111 is transmitted to the reception control device 21. The transmission control device 11 executes the operation shown in FIG. 5 when the coded packet is transmitted from the composite signal generation unit 111 to the multipath control unit 112.

First, the multipath control unit 112 in the transmission control device 11 selects at least one wireless link from the plurality of wireless links having different frequencies established between the transmission control device 11 and the reception control device 21 (step S301).

In the second example embodiment, one wireless link is selected from four wireless links in a round robin method. For example, when a wireless link through the nearest coded packet is transmitted is the wireless link on the wireless communication device 40a, a wireless link on which the next coded packet is transmitted is the wireless link on the wireless communication device 40b. In this way, one wireless link is selected from four wireless links in order of the wireless link on the wireless communication device 40a, the wireless link on the wireless communication device 40b, the wireless link on the wireless communication device 40c, and the wireless link on the wireless communication device 40d.

Next, the multipath control unit 112 transmits the coded packet sent from the composite signal generation unit 111 to the wireless link selected in step S301 (step S302), and the operation is ended.

FIG. 6 shows an operation procedure in which the signal recovery unit 212 included in the reception control device 21 decodes the coded packets transmitted by the multipath control unit 211 and decodes them into K packets. The signal recovery unit 212 executes the operation shown in FIG. 6 when the coded packets transmitted by the multipath control unit 211 are received.

First, the signal recovery unit 212 in the reception control device 21 performs a decoding process using the coded packets transmitted by the multipath control unit 211 and the accumulated coded packets (step S401). In the second example embodiment, decoding from the coded packet into K packets is performed with the Gaussian elimination.

Next, the signal recovery unit 212 determines whether the decoding from the coded packets into the K packets is completed by the process of step S401 (step S402)

When the decoding from the coded packets into the K packets is completed (step S402, YES), the signal recovery unit 212 transmits the decoded K packets to the device 70 (step S403).

Next, the signal recovery unit 212 notifies the ACK generation unit 213 that the decoding of the K packets is completed (step S404).

Subsequently, the signal recovery unit 212 discards the accumulated coded packets (step S405), and the operation is ended.

On the other hand, when the decoding from the coded packets into the K packets is not completed (step S402, NO), the signal recovery unit 212 accumulates the coded packets transmitted by the multipath control unit 211 (step S406), and the operation is ended.

FIG. 7 shows an operation procedure in which the multipath control unit 211 included in the reception control device 21 selects at least one wireless link from a plurality of wireless links having different frequencies and the ACK packet generated by the ACK generation unit 213 is transmitted to the transmission control device 11. The multipath control unit 211 executes the operation shown in FIG. 7 when the ACK packet sent by the ACK generation unit 213 is received.

First, the multipath control unit 211 in the reception control device 21 selects at least one wireless link from the plurality of wireless links having different frequencies established between the transmission control device 11 and the reception control device 21 (step S501). In the second example embodiment, all of the four wireless links are selected.

Next, the multipath control unit 211 transmits the ACK packet sent by the ACK generation unit 213 to the wireless link selected in step S501 (step S502), and the operation is ended.

Since the wireless communication system 2 uses the plurality of wireless links, when some channels of the plurality of wireless links are broken down due to radio wave interference, communication can be performed via another wireless link. Therefore, the wireless communication system 2 has higher reliability than a system using a single wireless link.

As described above, according to the second example embodiment of the present invention, it is possible to reduce the number of round trips and to realize low delay without requiring a large-capacity buffer.

### Modifications of Second Example Embodiment

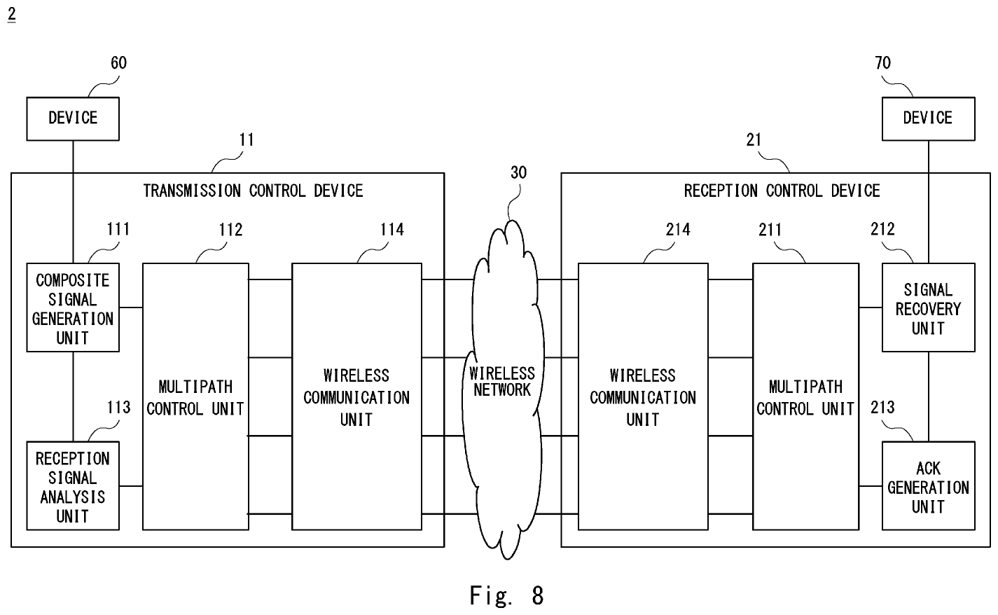

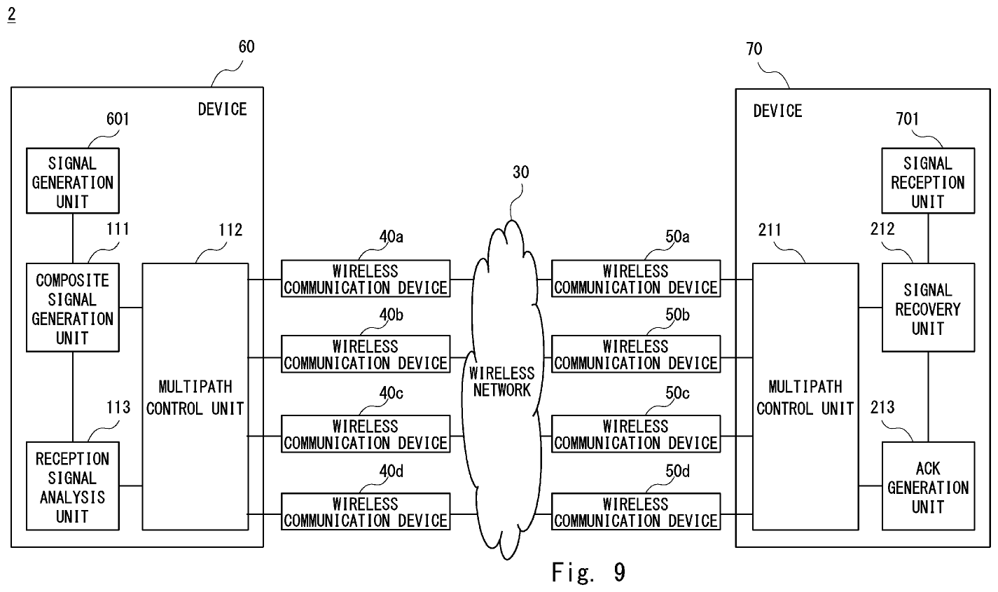

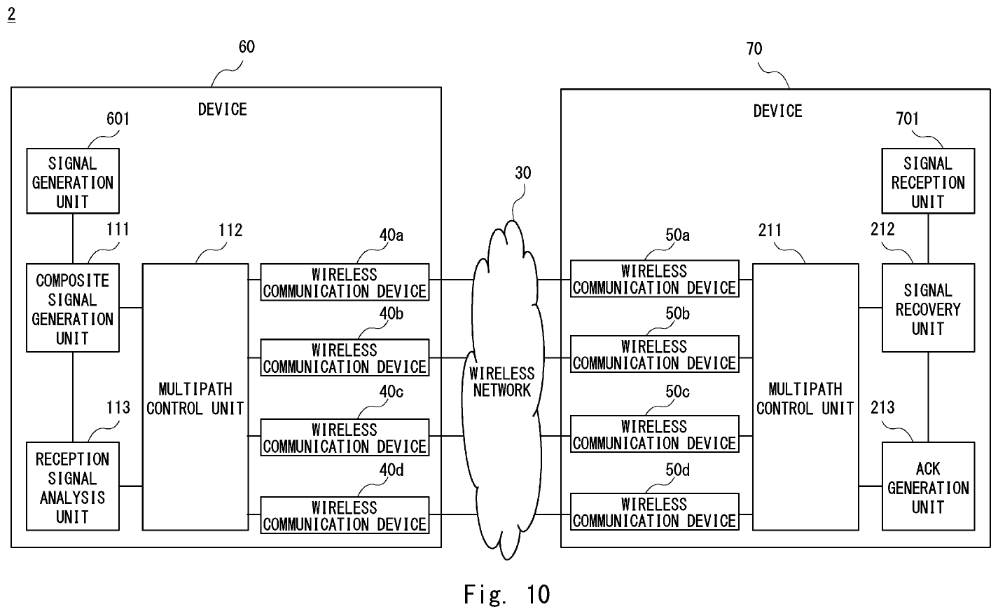

Modification of the second example embodiment will be described below with reference to FIGS. 8 to 10. FIG. 8 is a block diagram showing a configuration of one modification of the wireless communication system according to the second example embodiment. FIG. 9 is a block diagram showing a configuration of another modification of the wireless communication system according to the second example embodiment. FIG. 10 is a block diagram showing a configuration of further another modification of the wireless communication system according to the second example embodiment.

For example, the predetermined number K selected by the composite signal generation unit 111 in the transmission control device 11 may be set in consideration of the communication characteristics of the plurality of wireless links having different frequencies established between the transmission control device 11 and the reception control device 21. The communication characteristics to be considered at the time of setting are, for example, radio wave propagation characteristics such as propagation loss based on a frequency bandwidth of each of the wireless links or a frequency band of each of the wireless links. The communication characteristics to be considered at the time of setting may be antenna directivity, transmission power, or a signal processing function between the wireless communication device 40 and the wireless communication device 50 on the each of the wireless links, or a communication standard used in the each of the wireless links. The predetermined number K may be set in consideration of one of the communication characteristics described above, or may be set in consideration of two or more of the communication characteristics. Further, a method of calculating the predetermined number K is not particularly limited.

In the second example embodiment, the multipath control unit 112 in the transmission control device 11 selects one wireless link from the plurality of wireless links having different frequencies established between the transmission control device 11 and the reception control device 21 in step S301, using the round robin method. However, the number of wireless links to be selected may be two or more. A wireless link may be randomly selected from the plurality of wireless links. When a wireless link may be randomly selected from the plurality of wireless links, the number of wireless links to be selected may be arbitrary.

The multipath control unit 112 in the transmission control device 11 may determine priority of the wireless link in consideration of the communication characteristics of the plurality of wireless links, and may select a wireless link based on the determined priority. The communication characteristics to be considered at the time of setting are, for example, radio wave propagation characteristics such as propagation loss based on a frequency bandwidth of each of the wireless links or a frequency band of each of the wireless links. The communication characteristics to be considered at the time of setting may be antenna directivity, transmission power, or a signal processing function between the wireless communication device 40 and the wireless communication device 50 on the each of the wireless links, or a communication standard used in the each of the wireless links. The priority may be set in consideration of one of the communication characteristics described above, or may be set in consideration of two or more of the communication characteristics. Further, a method of calculating the priority is not particularly limited.

The wireless network 30 may be a wireless communication system standardized by 3 GPP (Third Generation Partnership Project). When the wireless network 30 is the wireless communication system standardized by 3 GPP, K packets are encoded to generate coded packet, and information related to the K packets selected at this time may be notified from the transmission control device 11 to the reception control device 21, as a control signal. The information related to the K packets is notified in a manner of a bitmap, for example.

As shown in FIG. 8, the wireless communication system according to the second example embodiment may have a configuration in which the transmission control device 11 further includes a wireless communication unit 114 and the reception control device 21 further includes a wireless communication unit 214. The wireless communication unit 114 has the same function as the wireless communication device 40. The wireless communication unit 214 has the same function as the wireless communication device 50.

Alternatively, as shown in FIG. 9, the wireless communication system according to the second example embodiment may have a configuration in which the device 60 includes the transmission control device 11 and the device 70 includes the reception control device 21. In the example shown in FIG. 9, the device 60 further includes a signal generation unit 601, and the device 70 further includes signal reception unit 701. The signal generation unit 601 generates a signal that can be transmitted to the device 70. The signal reception unit 701 receives the signal sent from the device 60 to the device 70.

Further, as shown in FIG. 10, in the second example embodiment, the device 60 may include the wireless communication device 40, and the device 70 may include the wireless communication device 50.

The modifications of the second example embodiment described above can be similarly performed in subsequent example embodiments.

### Third Example Embodiment

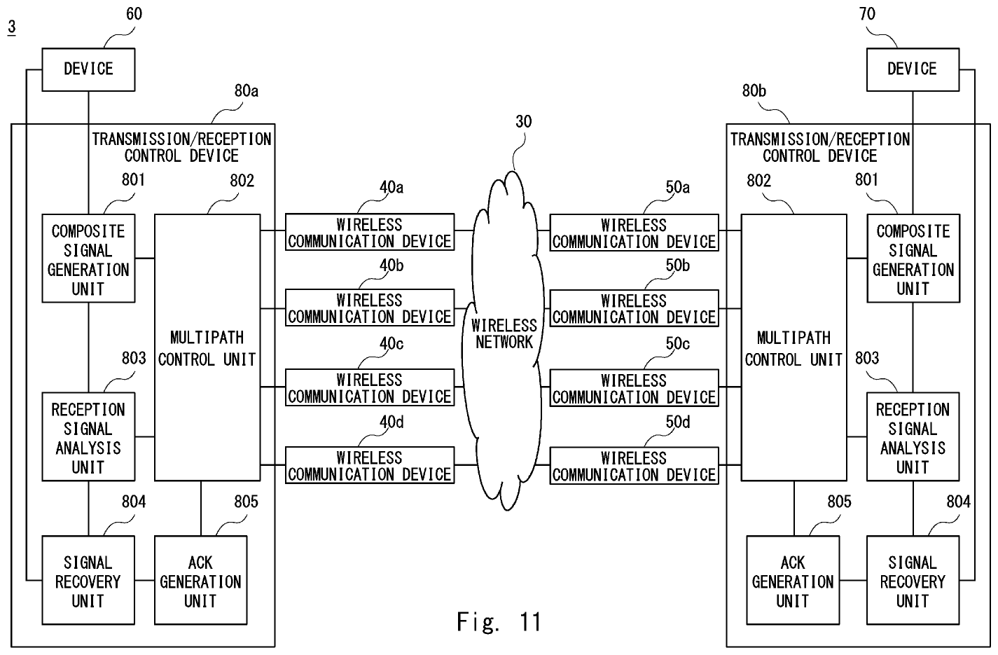

A third example embodiment of the present invention is an example embodiment in which bidirectional communication can be performed. First, a configuration of a wireless communication system according to the third example embodiment will be described with reference to FIG. 11. FIG. 11 is a block diagram showing a configuration of the wireless communication system according to the third example embodiment. As shown in FIG. 11, a wireless communication system 3 includes a transmission/reception control device 80a and a transmission/reception control device 80b instead of the transmission control device 11 and the reception control device 21 included in the wireless communication system 2. Other configurations are similar to those of the first and second example embodiments described above, and thus will not be repeatedly described as appropriate.

The transmission/reception control device 80a is connected to a wireless communication device 40a, a wireless communication device 40, a wireless communication device 40c, a wireless communication device 40d, and a device 60. The transmission/reception control device 80b is connected to a wireless communication device 50a, a wireless communication device 50b, a wireless communication device 50c, a wireless communication device 50d, and a device 70. In the following description, the transmission/reception control devices 80a and 80b are referred to as a “transmission/reception control device 80” at the time of description of a common item.

The wireless communication system 3 includes two or more wireless communication devices 40 and two or more wireless communication devices 50. In the wireless communication system 3, the number of wireless communication devices 40 is equal to the number of wireless communication devices 50. The wireless communication system 3 includes one or more devices 60 and one or more devices 70. For example, as shown in FIG. 2, the wireless communication system 2 includes one device 60 and one device 70. However, the wireless communication system 2 may include a plurality of devices 60 and a plurality of devices 70. The wireless communication system 2 may include a plurality of devices 60 and one device 70.

The transmission/reception control device 80a and the transmission/reception control device 80b communicate with each other via the plurality of wireless links having different frequencies established in a wireless network 30. In other words, the transmission/reception control device 80b is a communication partner of the transmission/reception control device 80a. In the example shown in FIG. 11, four wireless links are established. The four wireless links are established between the wireless communication device 40a and the wireless communication device 50a, between the wireless communication device 40b and the wireless communication device 50b, between the wireless communication device 40c and the wireless communication device 50c, and between the wireless communication device 40d and the wireless communication device 50d, respectively.

The transmission/reception control device 80 and the wireless communication devices 40 and 50 can communicate with each other via a communication line network. The transmission/reception control device 80a and the device 60 can communicate with each other via a communication line network. The transmission/reception control device 80b and the device 70 can communicate with each other via a communication line network. The communication line network is a local area network, for example. However, the communication line network can use a known network without being particularly limited. The communication line network is a personal area network, a CAN, a metropolitan area network, a wide area network, or a GAN. The communication line network may be an external network such as the Internet.

The communication may be performed between the transmission/reception control device 80 and the wireless communication devices 40 and 50, between the transmission/reception control device 80a and the device 60, between the transmission/reception control device 80b and the device 70 via an interface instead of the communication line network. The interface is, for example, an RS-232 or an RS-422, an RS-485, a USB, and an IEEE 1394.

The transmission/reception control device 80 includes an information processor and a communication interface which are not shown. The information processor includes a central processing unit and a storage unit which are not shown. The storage unit in the information processor is a memory and a hard disk drive. The transmission/reception control device 80 is configured to realize a function to be described below by executing a program stored in the storage unit with the central processing unit, for example.

The transmission/reception control device 80 may be an IP core. The IP core is, for example, an FPGA, an IC, and an LSI.

The transmission/reception control device 80 includes a composite signal generation unit 801, a multipath control unit 802, a reception signal analysis unit 803, a signal recovery unit 804, and an ACK generation unit 805. Operations of the composite signal generation unit 801, the multipath control unit 802, the reception signal analysis unit 803, the signal recovery unit 804, and the ACK generation unit 805 will be described below when the central processing unit, the transceiver, and the storage unit operate in cooperation with each other.

The composite signal generation unit 801 has the same function as the composite signal generation unit 111 in the wireless communication system 2. The multipath control unit 802 has the same function as the multipath control unit 112 in the wireless communication system 2. The reception signal analysis unit 803 has the same function as the reception signal analysis unit 113 in the wireless communication system 2. The signal recovery unit 804 has the same function as the signal recovery unit 212 in the wireless communication system 2. The ACK generation unit 805 has the same function as the ACK generation unit 213 in the wireless communication system 2.

### <Description of Operation>

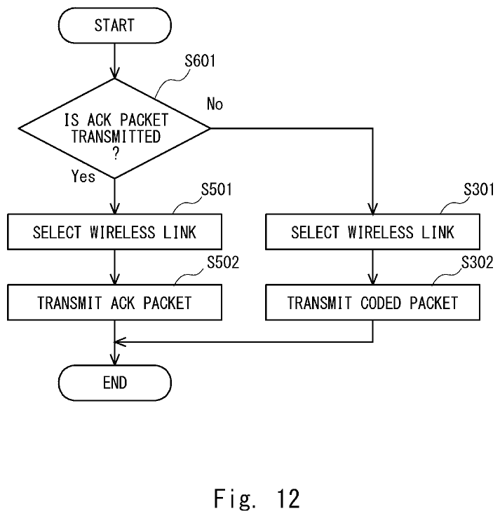

An operation of the wireless communication system according to the third example embodiment will be described in detail below with reference to FIG. 12. FIG. 12 is a flowchart illustrating an example of an operation in a signal transmitting process of the transmission/reception control device according to the third example embodiment.

An operation procedure of the composite signal generation unit 801 in the transmission/reception control device 80 is the same as the operation procedure of the composite signal generation unit 111 in the transmission control device 11.

FIG. 12 shows an operation procedure in which the multipath control unit 802 in the transmission/reception control device 80a selects at least one wireless link from a plurality of wireless links having different frequencies and coded packets and ACK packets are transmitted to the transmission/reception control device 80b. An operation procedure of the multipath control unit 802 in the transmission/reception control device 80b is the same as the operation procedure of the multipath control unit 802 in the transmission/reception control device 80a. The transmission/reception control device 80 executes the operation shown in FIG. 12 when the coded packet is transmitted from the composite signal generation unit 801 to the multipath control unit 802 and the ACK packet is transmitted from the ACK generation unit 805 to the multipath control unit 802.

In the operation shown in FIG. 12, a process of step S601 is newly added to the operation shown in FIG. 5. Therefore, the operation of added step S601 will be described below, and the duplicated description will be omitted.

First, the multipath control unit 112 in the transmission/reception control device 80a determines whether the ACK packet is transmitted from the ACK generation unit 805 (step S601).

When the ACK packet is transmitted from the ACK generation unit 805 (step S601, YES), the multipath control unit 802 performs an operation of step S301.

On the other hand, when the ACK packet is not transmitted from the ACK generation unit 805 (step S601, NO), the multipath control unit 802 performs an operation of step S501.

According to the above operation procedure, the multipath control unit 802 transmits the ACK packet in preference to the coded packet to the transmission/reception control device 80b.

As described above, according to the third example embodiment of the present invention, it is possible to reduce the number of round trips and to realize low delay without requiring a large-capacity buffer.

### Modifications of Third Example Embodiment

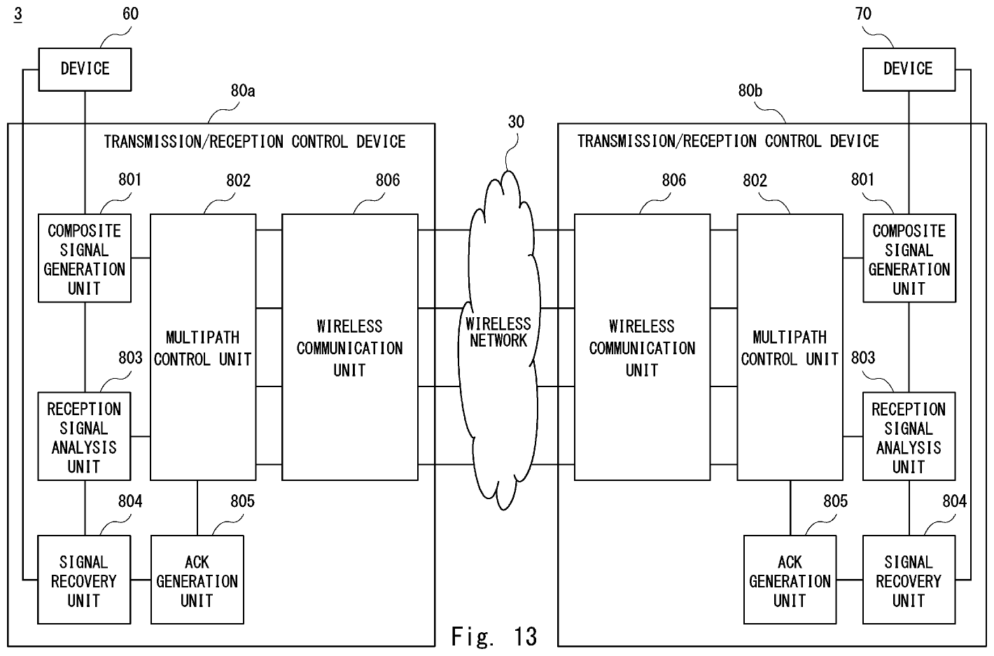

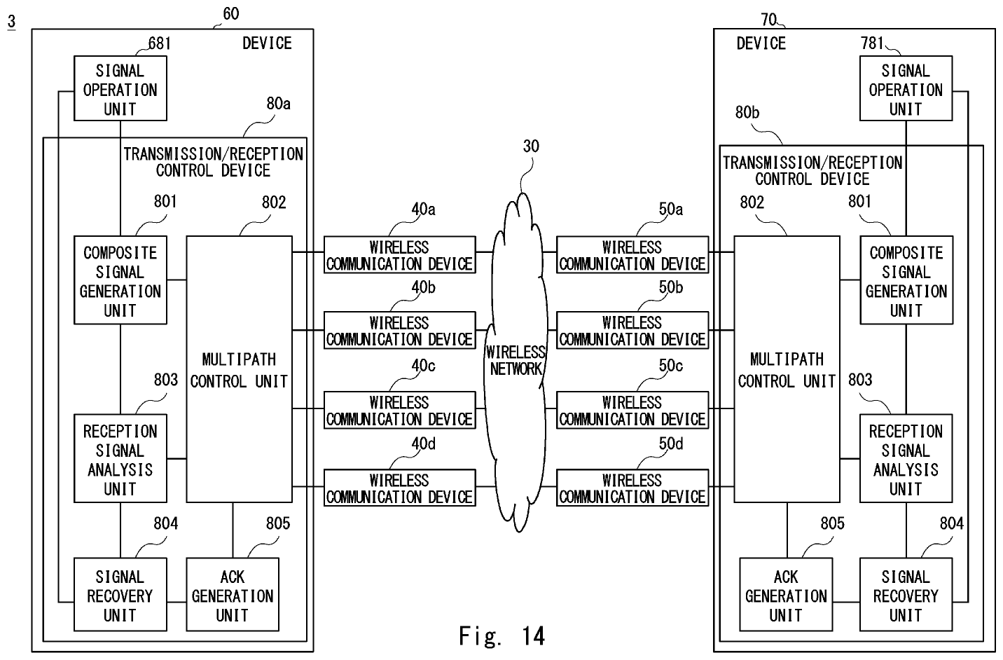

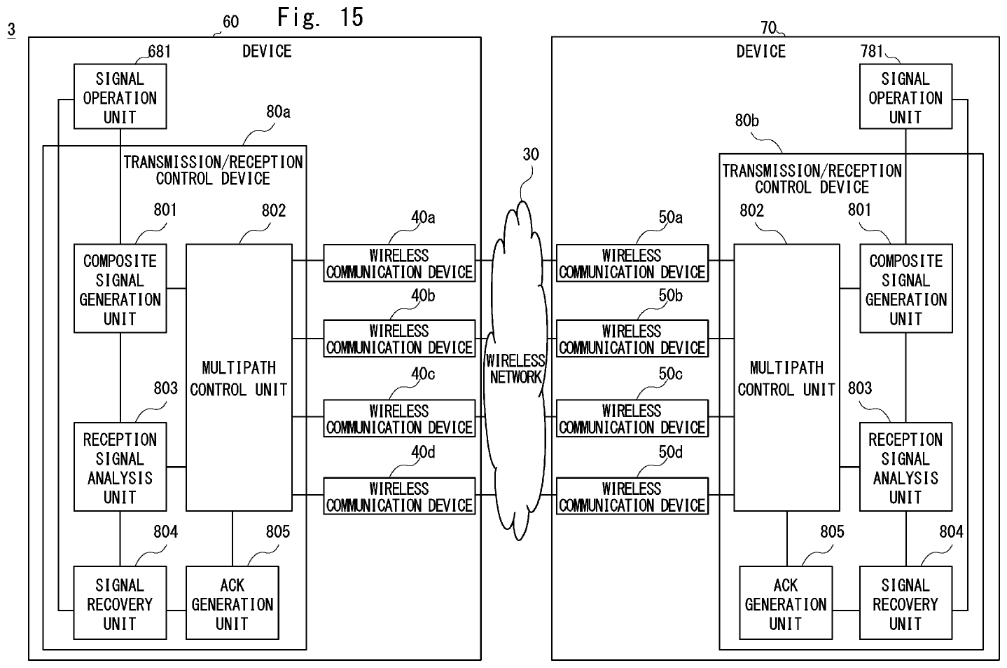

Modification of the third example embodiment will be described below with reference to FIGS. 13 to 15. FIG. 13 is a block diagram showing a configuration of one modification of the wireless communication system according to the third example embodiment. FIG. 14 is a block diagram showing a configuration of another modification of the wireless communication system according to the third example embodiment. FIG. 15 is a block diagram showing a configuration of further another modification of the wireless communication system according to the third example embodiment.

For example, the multipath control unit 802 in the transmission/reception control device 80 selects one wireless link or two or more wireless links from the plurality of wireless links having different frequencies established between the transmission/reception control devices 80, using the round robin method, similarly to the multipath control unit 112. Further, a wireless link may be randomly selected from the plurality of wireless links. When a wireless link may be randomly selected from the plurality of wireless links, the number of wireless links to be selected may be arbitrary.

The multipath control unit 802 in the transmission/reception control device 80 may determine priority of the wireless link in consideration of the communication characteristics of the plurality of wireless links, and may select a wireless link based on the determined priority. The communication characteristics to be considered at the time of setting are, for example, radio wave propagation characteristics such as propagation loss based on a frequency bandwidth of each of the wireless links or a frequency band of each of the wireless links. The communication characteristics to be considered at the time of setting may be antenna directivity, transmission power, or a signal processing function between the wireless communication device 40 and the wireless communication device 50 on the each of the wireless links, or a communication standard used in the each of the wireless links. The priority may be set in consideration of one of the communication characteristics described above, or may be set in consideration of two or more of the communication characteristics. Further, a method of calculating the priority is not particularly limited. When the ACK generation unit 805 transmits the ACK packet, a wireless link can also be selected by the above method.

As shown in FIG. 13, the wireless communication system according to the third example embodiment may have a configuration in which the transmission/reception control device 80 further includes a wireless communication unit 806. The wireless communication unit 806 has the same function as the wireless communication devices 40 and 50.

Alternatively, as shown in FIG. 14, the wireless communication system according to the third example embodiment may have a configuration in which each of the devices 60 and 70 includes the transmission/reception control device 80. In the example shown in FIG. 14, the device 60 further includes a signal operation unit 681, and the device 70 further includes a signal operation unit 781. The signal operation unit 681 generates a signal which can be transmitted to the device 70, and receives the signal sent from the device 70 to the device 60. The signal operation unit 781 generates a signal which can be transmitted to the device 60, and receives the signal sent from the device 60 to the device 70.

Further, as shown in FIG. 15, in the third example embodiment, the device 60 may include the wireless communication device 40, and the device 70 may include the wireless communication device 50.

The modifications of the third example embodiment described above can be similarly performed in subsequent example embodiments.

### Fourth Example Embodiment

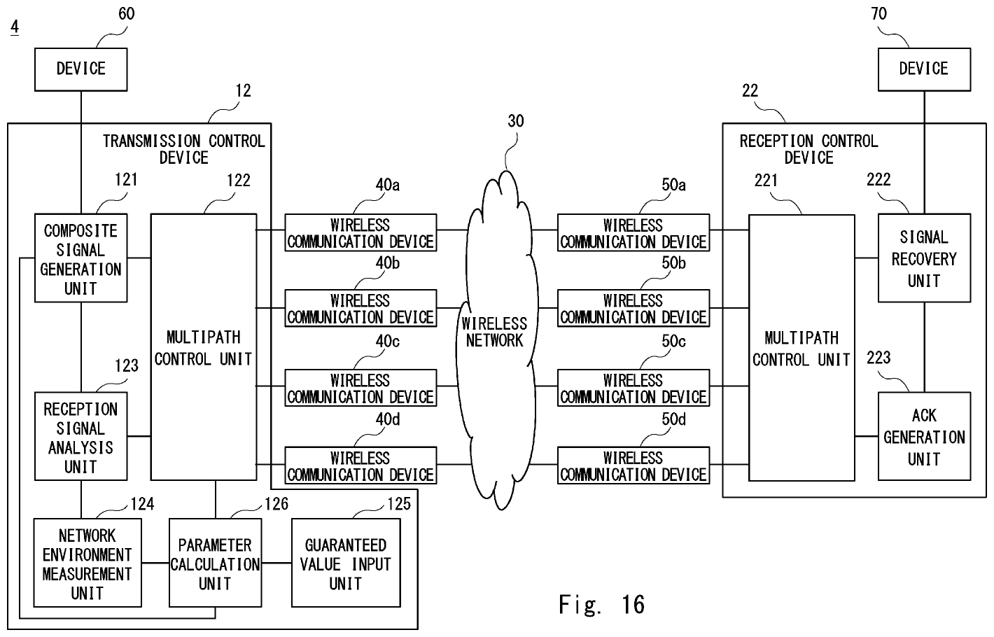

A fourth example embodiment of the present invention is an example embodiment in which a network environment is measured to determine a predetermined number K based on the measurement result. First, a configuration of a wireless communication system according to the fourth example embodiment will be described with reference to FIG. 16. FIG. 16 is a block diagram showing a configuration of the wireless communication system according to the fourth example embodiment. As shown in FIG. 16, a wireless communication system 4 includes a transmission control device 12 and a reception control device 22 instead of the transmission control device 11 and the reception control device 21 included in the wireless communication system 2. Other configurations are similar to those of the first and second example embodiments described above, and thus will not be repeatedly described as appropriate.

The transmission control device 12 is connected to a wireless communication device 40a, a wireless communication device 40, a wireless communication device 40c, a wireless communication device 40d, and a device 60. The reception control device 22 is connected to a wireless communication device 50a, a wireless communication device 50b, a wireless communication device 50c, a wireless communication device 50d, and a device 70. The wireless communication system 4 includes two or more wireless communication devices 40 and two or more wireless communication devices 50. In the wireless communication system 4, the number of wireless communication devices 40 is equal to the number of wireless communication devices 50. For example, as shown in FIG. 16, the wireless communication system 2 includes four wireless communication devices 40 and four wireless communication devices 50. However the wireless communication system 2 may include two wireless communication devices 40 and two wireless communication devices 50.

The transmission control device 12 and the reception control device 22 communicate with each other via the plurality of wireless link having different frequencies established in a wireless network 30. In the example shown in FIG. 16, four wireless links are established. The four wireless links are established between the wireless communication device 40a and the wireless communication device 50a, between the wireless communication device 40b and the wireless communication device 50b, between the wireless communication device 40c and the wireless communication device 50c, and between the wireless communication device 40d and the wireless communication device 50d, respectively.

The transmission control device 12 and the wireless communication device 40 can communicate with each other via a communication line network. The transmission control device 12 and the device 60 can communicate with each other via a communication line network. The reception control device 22 and the wireless communication device 50 can communicate with each other via a communication line network. The reception control device 22 and the device 70 can communicate with each other via a communication line network. The communication line network is a local area network, for example. However, the communication line network can use a known network without being particularly limited. The communication line network is a personal area network, a metropolitan area network, a wide area network, or a GAN. The communication line network may be an external network such as the Internet.

The communication may be performed between the transmission control device 12 and the wireless communication device 40, between the transmission control device 12 and the device 60, between the reception control device 22 and the wireless communication device 50, and between the reception control device 22 and the device 70 via an interface instead of the communication line network. The interface is, for example, an RS-232 or an RS-422, an RS-485, a USB, and an IEEE 1394.

The transmission control device 12 includes an information processor and a communication interface which are not shown. The information processor includes a central processing unit and a storage unit which are not shown. The storage unit in the information processor is a memory and a hard disk drive. The transmission control device 12 is configured to realize a function to be described below by executing a program stored in the storage unit with the central processing unit, for example. The transmission control device 12 may be an IP core. The IP core is, for example, an FPGA, an IC, and an LSI.

The reception control device 22 includes an information processor and a communication interface which are not shown. The information processor includes a central processing unit and a storage unit which are not shown. The storage unit in the information processor is a memory and a hard disk drive. The reception control device 22 is configured to realize a function to be described below by executing a program stored in the storage unit with the central processing unit, for example. The reception control device 22 may be an IP core.

The reception control device 22 includes a multipath control unit 221, a signal recovery unit 222, and an ACK generation unit 223. Operations of the multipath control unit 221, the signal recovery unit 222, and the ACK generation unit 223 will be described below when the central processing unit, the transceiver, and the storage unit in the reception control device 22 operate in cooperation with one another.

The multipath control unit 221 has the same function as the multipath control unit 211 in the wireless communication system 2. The multipath control unit 221 further has a function of measuring information related to communication characteristics for each of the plurality of wireless links established between the transmission control device 12 and the reception control device 22. In the fourth example embodiment, a description will be given below with respect to a case of measuring a rate of packet loss that is generated until K packets are successfully received on the wireless link, as information related to the communication characteristics.

A method of measuring the packet loss is not particularly limited. For the packet loss, a loss packet is determined from a sequence number described in a header of the coded packet, for example. The packet loss may be determined by extraction of information related to a loss packet detected by the wireless communication device 50 corresponding to the wireless link. Further, instead of the packet loss, for example, by measurement of a reception rate, a delay time, or the number of transmission within a predetermined time, the packet loss may be determined. The measured communication characteristics are used for the ACK generation unit 223.

Although the details will be described below, the multipath control unit 221 selects at least one wireless link from the plurality of wireless links having different frequencies established between the transmission control device 12 and the reception control device 22. Then, the multipath control unit 221 selects a wireless link corresponding to the communication characteristics stored in a status packet generated by the ACK generation unit 223, and transmits the status packet to the transmission control device 12. The status packet transmitted by the multipath control unit 221 is transmitted from the wireless communication device 50 on the selected wireless link. The transmitted status packet is received by the wireless communication device 40 on the same wireless link, and arrives at the transmission control device 12.

The signal recovery unit 222 has the same function as the signal recovery unit 212 in the wireless communication system 2. The ACK generation unit 223 has the same function as the ACK generation unit 213 in the wireless communication system 2. The ACK generation unit 223 further has a function of generating a status packet that stores information related to the communication characteristics measured by the multipath control unit 221 for each of the plurality of wireless links established between the transmission control device 12 and the reception control device 22. The generated status packet is transmitted from the multipath control unit 221 to the transmission control device 12.

The transmission control device 12 includes a composite signal generation unit 121, a multipath control unit 122, a reception signal analysis unit 123, a network environment measurement unit 124, a guaranteed value input unit 125, and a parameter calculation unit 126. The transmission control device 12 includes an information processor and a communication interface which are not shown. The information processor includes a central processing unit, a transceiver, and a storage unit. Operations of the composite signal generation unit 121, the multipath control unit 122, the reception signal analysis unit 123, the network environment measurement unit 124, the guaranteed value input unit 125, and the parameter calculation unit 126 will be described below when the central processing unit, the transceiver, and the storage unit operate in cooperation with one another.

The composite signal generation unit 121 has the same function as the composite signal generation unit 111 in the wireless communication system 2. The composite signal generation unit 121 further has a function of selecting the predetermined number of K packets calculated by the parameter calculation unit 126, from the accumulated packets. The composite signal generation unit 121 generates coded packets from the selected K packets. The coded packet is generated by an encoding process due to rateless coding, for example. In the encoding process due to the rateless coding, at least one packet is selected from K packets to generate a coding packet obtained by an exclusive OR (XOR).

In the fourth example embodiment, a case will be described below in which the encoding process due to the rateless coding is performed as in the second example embodiment. The coded packet generated by the composite signal generation unit 121 is transmitted to the multipath control unit 122. The encoding process due to the rateless coding is repeated until an ACK notification is received from the reception signal analysis unit 123. When the composite signal generation unit 121 receives the ACK notification from the reception signal analysis unit 123, the encoding process is ended, and the K packets targeted for the encoding process are discarded.

The multipath control unit 122 establishes a plurality of wireless links having different frequencies in the wireless network 30 to enable communication between the transmission control device 12 and the reception control device 22. The multipath control unit 122 selects at least one wireless link from the plurality of wireless links having different frequencies established in the wireless network 30, and transmits the coded packet transmitted from the composite signal generation unit 121 to the reception control device 22. The coded packet transmitted from the multipath control unit 122 is transmitted from the wireless communication device 40 on the selected wireless link. The transmitted coded packet is received by the wireless communication device 50 on the same wireless link, and arrives at the multipath control unit 221.

Although the details will be described below, the multipath control unit 122 receives ACK packets from the plurality of wireless links having different frequencies established between the transmission control device 12 and the reception control device 22. The ACK packets received by the multipath control unit 122 are generated by an ACK generation unit 223 included in the reception control device 22. The received ACK packets are transmitted to the reception signal analysis unit 123. The multipath control unit 122 further receives status packets from the plurality of wireless links having different frequencies established between the transmission control device 12 and the reception control device 22. The status packets received by the multipath control unit 122 are generated by the ACK generation unit 223 in the reception control device 22. The status packets received by the multipath control unit 122 are transmitted to the reception signal analysis unit 123.

The reception signal analysis unit 123 notifies the composite signal generation unit 121 of ACK when the ACK packets arrive, similarly to the reception signal analysis unit 113 in the wireless communication system 2. The reception signal analysis unit 123 further transmits the status packets to the network environment measurement unit 124 when the status packets generated by the ACK generation unit 223 in the reception control device 22 arrive.

The network environment measurement unit 124 measures communication characteristics of the wireless network 30 from the ACK packets transmitted by the reception signal analysis unit 123. In the fourth example embodiment, the network environment measurement unit 124 measures a round trip time (RTT) in the wireless network 30. The RTT is measured as indicated by Formula 1. In Formula (1) described below, a reception TS is a time (time stamp) at which the ACK packets are received in the transmission control device 12. However, the reception TS may be a time at which the ACK packets are received in the multipath control unit 122, the reception signal analysis unit 123, or the network environment measurement unit 124. The reception TS may be a time at which the ACK packets are processed in the reception signal analysis unit 123 or the network environment measurement unit 124. A transmission TS is a time (time stamp) at which the coded packets related to the ACK packets are first transmitted in the transmission control device 12.

[Formula 1]

RTT=Reception TS−Transmission TS Formula (1)

The transmission control device 12 can measure and hold the reception TS and the transmission TS. The transmission TS may be described in a header of the coded packet. When the transmission TS is described in the header of the coded packet, the ACK generation unit 223 may describe the transmission TS, which is described in the header of the coded packet, in a header of the generated ACK packet.

Formula (1) may be rewritten as Formula (2) described below. In Formula (2), a symbol ΔT indicates an internal processing time related to other than the data transmission/reception between the transmission control device 12 and the reception control device 22. The transmission control device 12 and the reception control device 22 can measure and hold the internal processing time. The measured communication characteristics of the wireless network 30 are used in the parameter calculation unit 126. Further, the network environment measurement unit 124 measures communication characteristics for each of the plurality of wireless links established between the transmission control device 12 and the reception control device 22, from the status packet transmitted from the reception signal analysis unit 123. In the fourth example embodiment, a packet loss rate of the wireless link described in the status packet is measured. The measured communication characteristics of each of the wireless links are used in the parameter calculation unit 126.

[Formula 2]

RTT=Reception TS−Transmission TS−ΔT Formula (2)

The guaranteed value input unit 125 accepts a communication characteristic designated by a user. In the fourth example embodiment, the communication characteristic designated by the user is defined as a delay time. The communication characteristic designated by the user may be a transmission rate or a packet transmission interval of a wireless section, a packet loss rate, or a packet reception rate. The guaranteed value input unit 125 may accept one communication characteristic, or may accept a plurality of communication characteristics. The communication characteristics designated by the user are used in the parameter calculation unit 126.

The parameter calculation unit 126 calculates a predetermined number K using the communication characteristics of the wireless network 30 measured by the network environment measurement unit 124, the communication characteristics of each of the wireless links measured by the network environment measurement unit 124, and the communication characteristics accepted by the guaranteed value input unit 125. The predetermined number K calculated by the parameter calculation unit 126 is used when K packets are selected from the packets accumulated by the composite signal generation unit 121.

In the fourth example embodiment, the predetermined number K is derived from Formulas (3) to (5) described below. In Formula (3), a right side indicates a time required for the final packet arriving at the composite signal generation unit 121 from the device 60 to arrive at the device 70. In Formula (3), T indicates a delay time accepted in the guaranteed value input unit 125. In the right side of Formula (3), S indicates the number of transmissions of the coded packets required for the final packet arriving at the composite signal generation unit 121 from the device 60 to arrive at the device 70. PacketSize indicates a size of the packet arriving at the composite signal generation unit 121 from the device 60. Bandwidth indicates a bandwidth [bps] of the wireless network 30. RTT indicates an RTT of the wireless network 30 measured by the network environment measurement unit 124.

$$\begin{matrix}[ Formula 3 ] & \\ T ≦ \frac{S \times PacketSize}{Bandwidth} + RTT \times ⌊ Buff \div K ⌋ & Formula ( 3 )\end{matrix}$$

Formula (4) indicates a cumulative density function of the number of transmissions of the coded packets required for the final packet arriving at the composite signal generation unit 121 from the device 60 to arrive at the device 70. In Formula (4), reference numeral p(x) indicates a probability density distribution indicating that K packets are decoded in the reception control device 22 when the transmission control device 12 transmits x coded packets. The p(x) is calculated by Formula (5). The predetermined number K determined by Formulas (3) to (5) is used in the composite signal generation unit 121.

$$\begin{matrix}[ Formula 4 ] & \\ P ( S ) = {\int }_{- ∞}^{S} {[ p ( x ) ]}^{⌊ Buff \div K ⌋} dx & Formula ( 4 ) \\ [ Formula 5 ] & \\ p ( x ) = ( \begin{matrix}x \\ K\end{matrix} ) {{p}^{K} ( 1 - p )}^{x - K} & Formula ( 5 )\end{matrix}$$

The parameter calculation unit 126 can further calculate an index using the communication characteristics of the wireless network 30 measured by the network environment measurement unit 124, the communication characteristics of each of the wireless links measured by the network environment measurement unit 124, and the communication characteristics accepted by the guaranteed value input unit 125. The index calculated by the parameter calculation unit 126 is used for selection of the wireless link on which the composite signal is transmitted.

In the fourth example embodiment, an index related to the selection of the wireless link is calculated using Formula (6) described below. In Formula (6), reference numeral i is an identification number of the wireless link. Reference numeral L indicates a total number of wireless links. Reference numeral a indicates a weighting coefficient. In the fourth example embodiment, the weighting coefficient α is set to 1. However, the weighting coefficient α may be any value other than 1. PacketLossRatio(i) indicates a packet loss rate of a wireless link i measured by the network environment measurement unit 124.

$$\begin{matrix}[ Formula 6 ] & \\ N ( i ) = \frac{1 - PacketLossRatio ( i )}{{\sum }_{i ∈ L} {( 1 - PacketLossRatio ( i ) )}^{α}} & Formula ( 6 )\end{matrix}$$

Based on the index related to the selection of the wireless link calculated by Formula (6), the multipath control unit 122 selects at least one wireless link from the plurality of wireless links having different frequencies established between the transmission control device 12 and the reception control device 22. The coded packet sent by the composite signal generation unit 121 is transmitted to the reception control device 22 through the at least one selected wireless link.

In the fourth example embodiment, at least one wireless link is selected from the plurality of wireless links having different frequencies established between the transmission control device 12 and the reception control device 22 such that the selection probability of each of the wireless links becomes an index N(i) calculated by Formula (6). A method of selecting the wireless link is not particularly limited as long as the selection probability of each of the wireless links can be the index N(i) calculated by Formula (6). The number of wireless links to be selected is not particularly limited as long as the selection probability of each of the wireless links can be the index N(i) calculated by Formula (6).

### <Description of Operation>

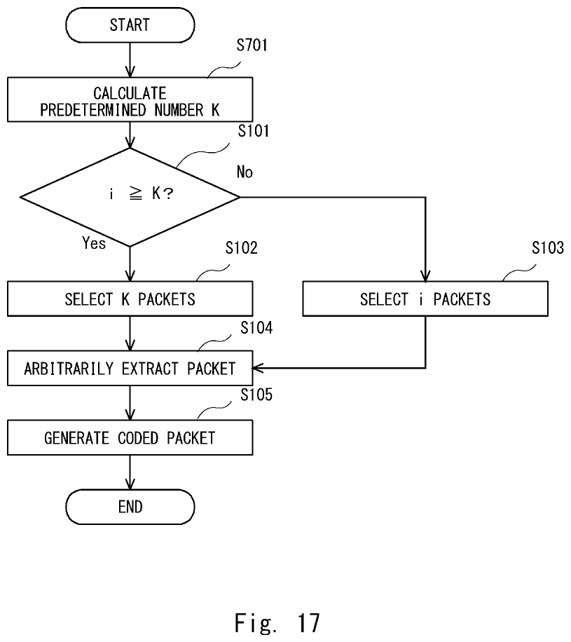

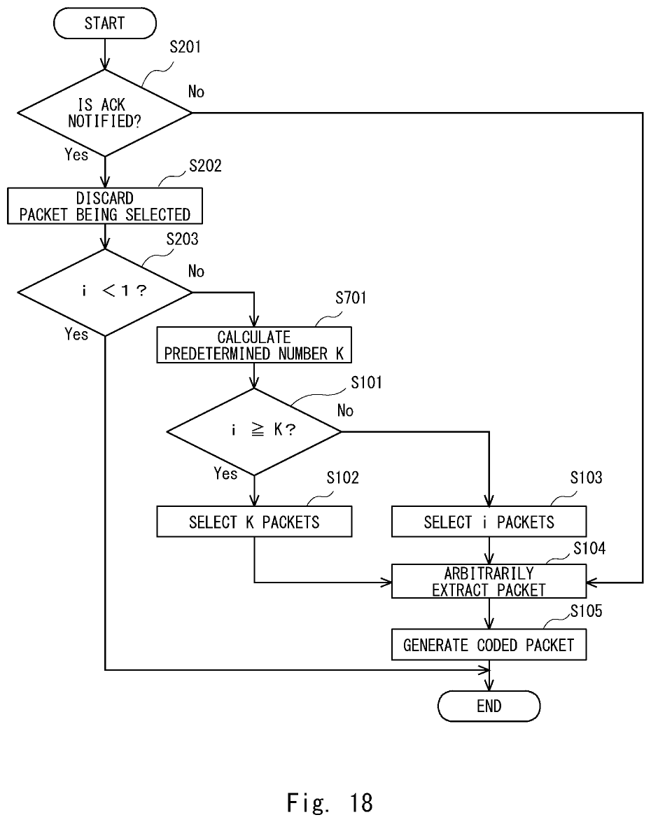

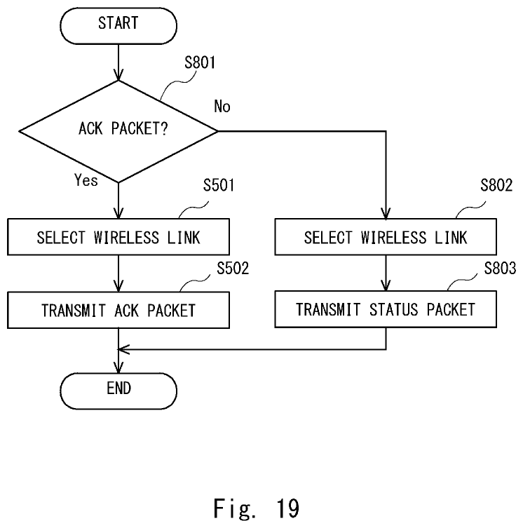

An operation of the wireless communication system according to the fourth example embodiment will be described in detail below with reference to FIGS. 17 to 19. FIG. 17 is a flowchart illustrating an example of an operation in the encoding process of the transmission control device according to the fourth example embodiment. FIG. 18 is a flowchart illustrating another example of the operation in the encoding process of the transmission control device according to the fourth example embodiment. FIG. 19 is a flowchart illustrating an example of an operation in a signal transmitting process of the reception control device according to the fourth example embodiment.

FIG. 17 shows an operation procedure in which the composite signal generation unit 121 of the transmission control device 12 selects a predetermined number K of packets from the accumulated packets, codes the selected predetermined number K of packets, and generates coded packets. The transmission control device 12 executes the operation shown in FIG. 17 when the number of packets accumulated in the composite signal generation unit 121 changes from 0 to 1.

In the operation shown in FIG. 17, a process of step S701 is newly added to the operation shown in FIG. 3. Therefore, an operation of added step S701 will be described below, and the duplicated description will be omitted.

When the number i of packets accumulated in the composite signal generation unit 121 changes from 0 to 1, the parameter calculation unit 126 in the transmission control device 12 calculates a predetermined number K required at the time of generation of the composite signal (step S701).

After the processing of step S701, the composite signal generation unit 121 of the transmission control device 12 determines whether the number i of packets accumulated in the composite signal generation unit 121 is the predetermined number K or more (step S101).

FIG. 18 shows an operation procedure in which the composite signal generation unit 121 of the transmission control device 12 selects a predetermined number K of packets from the accumulated packets, codes the selected predetermined number K of packets, and generates coded packets. The transmission control device 12 executes the operation shown in FIG. 18 when the number of packets accumulated in the composite signal generation unit 121 is 1 or more.

In the operation shown in FIG. 18, a process of step S701 is newly added to the operation shown in FIG. 4. Therefore, an operation of added step S701 will be described below, and the duplicated description will be omitted.

The composite signal generation unit 121 determines in step S203 whether the number i of packets accumulated in the composite signal generation unit 121 is less than 1. When the number i of packets accumulated in the composite signal generation unit 121 is 1 or more (step S203, NO), the parameter calculation unit 126 of the transmission control device 12 calculates a predetermined number K required at the time of generation of the composite signal (step S701).

After the processing of step S701, the composite signal generation unit 121 of the transmission control device 12 determines whether the number i of packets accumulated in the composite signal generation unit 121 is the predetermined number K or more (step S101).

The operation procedure of the multipath control unit 122 in the transmission control device 12 is similar to the operation procedure of the multipath control unit 112 in the wireless communication system 2. The operation procedure of the signal recovery unit 222 in the reception control device 22 is similar to the operation procedure of the signal recovery unit 212 in the wireless communication system 2.

FIG. 19 shows an operation procedure in which the multipath control unit 221 in the reception control device 22 transmits the ACK packet generated by the ACK generation unit 223 to the transmission control device 12 and transmits the status packet generated by the ACK generation unit 223 to the transmission control device 12. The multipath control unit 221 executes the operation shown in FIG. 19 when the ACK packet or the status packet sent by the ACK generation unit 223 is received.

In the operation shown in FIG. 19, processes of steps S801 to S803 are newly added to the operation shown in FIG. 7. Therefore, operations of added steps S801 to step S803 will be described below, and the duplicated description will be omitted.

First, the multipath control unit 221 in the reception control device 22 determines whether the packet sent from the ACK generation unit 223 is an ACK packet (step S801).

When the packet sent from the ACK generation unit 223 is the ACK packet (step S801, YES), the multipath control unit 221 selects at least one wireless link from a plurality of wireless links having different frequencies (step S501).

On the other hand, when the packet sent from the ACK generation unit 223 is not the ACK packet (step S801, NO), the multipath control unit 221 determines that the packet sent from the ACK generation unit 223 is a status packet. Then, the multipath control unit 221 selects a wireless link corresponding to the status packet (step S802).

Next, the multipath control unit 221 transmits the status packet sent from the ACK generation unit 223, to the wireless link selected in step S802 (step S502), and the operation is ended.

As described above, according to the fourth example embodiment of the present invention, it is possible to reduce the number of round trips and to realize low delay without requiring a large-capacity buffer.

In the fourth example embodiment, the number of signals to be combined can be changed according to the communication characteristics. Accordingly, since many signals can be combined when the communication characteristics are good, the number of round trips can be further reduced. In fourth example embodiment, it is possible to select a wireless link to which the composite signal is transmitted according to the communication characteristics. Therefore, since many composite signals can be transmitted to the wireless link having good communication characteristics, the delay time can be further reduced.

### Modifications of Fourth Example Embodiment

In the fourth example embodiment, for example, the ACK generation unit 223 in the reception control device 22 measures the packet loss rate for each of the plurality of wireless links established between the transmission control device 12 and the reception control device 22. However, the network environment measurement unit 124 in the transmission control device 12 may measure the packet loss rate for each of the plurality of wireless links.

When the network environment measurement unit 124 measures the packet loss rate, the ACK generation unit 223 in the reception control device 22 generates a predetermined number K of status packets when receiving K coded packets for each of the wireless links. The network environment measurement unit 124 in the transmission control device 12 records the number of coded packets transmitted at each of the wireless links. Upon receiving the status packet, the network environment measurement unit 124 extracts the predetermined number K of status packets, and obtains a packet loss rate with Formula (7) described below, using the number of coded packets transmitted on the wireless link.

[Formula 7]

Packet loss rate=1−(Predetermined number K/Number of coded packets to be transmitted) Formula (7)

The predetermined number K may be set in advance in the transmission control device 12 and the reception control device 22. When the predetermined number K is set in advance, it is not necessary to store the predetermined number K in the status packet. Further, as the communication characteristics, a transmission rate of a wireless section, an RTT of a wireless section, an arrival delay, a packet reception interval, or a packet reception rate may be measured instead of the packet loss rate.

The communication characteristics may be measured by the ACK generation unit 223 in the reception control device 22, and may be notified to the network environment measurement unit 124 in the transmission control device 12, using the status packet. The communication characteristics may be measured by the network environment measurement unit 124 of the transmission control device 12. When the network environment measurement unit 124 measures the communication characteristics, the ACK generation unit 223 in the reception control device 22 may measure information necessary for measurement, and may notify the network environment measurement unit 124 in the transmission control device 12 of the information, using the status packet.

The method of calculating the index related to the selection of the wireless link is not limited to Formula (6). For example, the index related to the selection of the wireless link is calculated using Formula (8) described below when a transmission rate and a packet reception rate in a wireless section, for example, measured values related to a transfer speed are used.

$$\begin{matrix}[ Formula 8 ] & \\ N ( i ) = \frac{Throughput ( i )}{{\sum }_{i ∈ L} {( Throughput ( i ) )}^{α}} & Formula ( 8 )\end{matrix}$$

The index related to the selection of the wireless link is calculated using Formula (9) described below in the case of using the measured value related to the time such as RTT and arrival delay of the wireless section.

$$\begin{matrix}[ Formula 9 ] & \\ N ( i ) = \frac{\frac{1}{time ( i )}}{{\sum }_{i ∈ L} {( \frac{1}{time ( i )} )}^{α}} & Formula ( 9 )\end{matrix}$$

Formulas (6), (8), and (9) can be appropriately modified. For example, coefficients and variables may be added in consideration of radio wave propagation characteristics such as propagation loss based on a frequency bandwidth of each of the wireless links or a frequency bandwidth of each of the wireless links. Coefficients and variables may be added in consideration of antenna directivity, transmission power, and a signal processing function between the wireless communication device 40 and the wireless communication device 50 on the each of the wireless links, and a communication standard used in each of the wireless links.

The index related to the selection of the wireless link may be calculated from one measured value, or may be calculated from a plurality of measured values. In the case of the calculation from the plurality of measured values, for example, the sum of the value calculated from Formula (6) and the value calculated from Formula (8) may be used as the index related to the selection of the wireless link. The product of the value calculated from Formula (6) and the value calculated from Formula (8) may be used as the index related to the selection of the wireless link. In addition, the value calculated from a formula, to which the coefficients and the variables are added, may be used as the index related to the selection of the wireless link.

In the fourth example embodiment, the wireless link is selected based on the index calculated from Formula (6) when the coded packet is transmitted to the reception control device 22. However, the wireless link may be selected based on the modification of the index related to the selection of the wireless link. At this time, the number of wireless links to be selected is not particularly limited.

In the fourth example embodiment, the wireless link is selected such that the selection probability of each of the wireless links serves as the index calculated by Formula (6). However, the wireless link may be selected such that the selection sequence of the wireless link serves as the index calculated by Formula (6). The wireless link may be selected such that the number of times of selection of the wireless link serves as the index calculated by Formula (6).

The fourth example embodiment can also be implemented in the configuration of the modification of the second example embodiment, the configuration of the third example embodiment, and the configuration of the modification of the third example embodiment.

The modifications of the fourth example embodiment described above can be similarly performed in a subsequent example embodiment.

### Fifth Example Embodiment

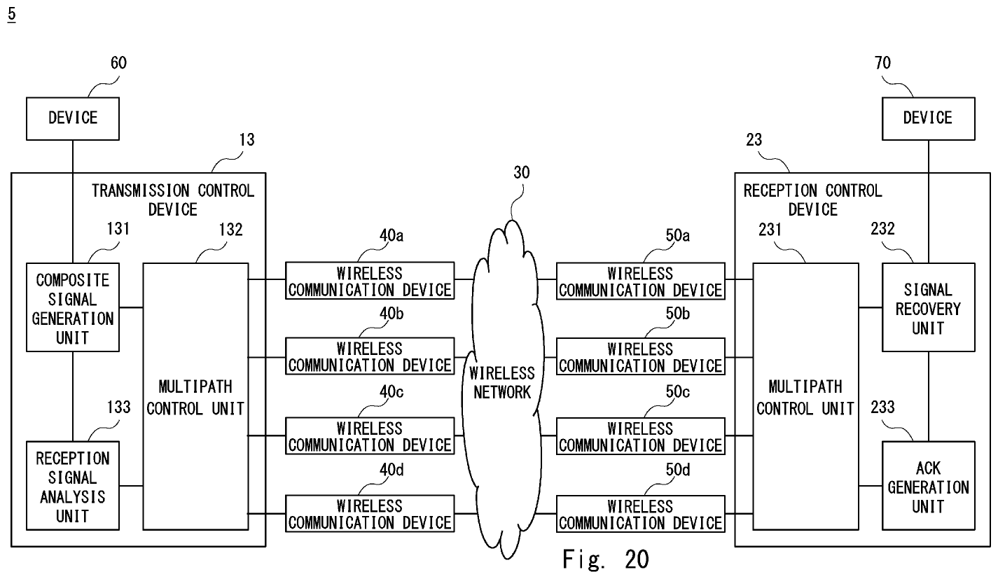

A fifth example embodiment of the present invention is an example embodiment of combining an analog signal. A configuration of a wireless communication system according to the fifth example embodiment will be described with reference to FIG. 20. FIG. 20 is a block diagram showing a configuration of the wireless communication system according to the fifth example embodiment. As shown in FIG. 20, a wireless communication system 5 includes a transmission control device 13 and a reception control device 23 instead of the transmission control device 11 and the reception control device 21 included in the wireless communication system 2. Other configurations are similar to those of the first to fourth example embodiments described above, and thus will not be repeatedly described as appropriate.

The transmission control device 13 is connected to a wireless communication device 40a, a wireless communication device 40, a wireless communication device 40c, a wireless communication device 40d, and a device 60. The reception control device 23 is connected to a wireless communication device 50a, a wireless communication device 50b, a wireless communication device 50c, a wireless communication device 50d, and a device 70. The wireless communication system 5 includes two or more wireless communication devices 40 and two or more wireless communication devices 50. In the wireless communication system 5, the number of wireless communication devices 40 in the wireless communication system 5 is equal to the number of wireless communication devices 50 in the wireless communication system 5. The wireless communication system 5 includes one or more devices 60 and one or more devices 70. For example, as shown in FIG. 2, the wireless communication system 5 includes one device 60 and one device 70. However, the wireless communication system 5 may include a plurality of devices 60 and a plurality of devices 70. The wireless communication system 5 may include a plurality of devices 60 and one device 70.

The transmission control device 13 and the reception control device 23 communicate with each other via a plurality of wireless links having different frequencies established in a wireless network 30. In the example shown in FIG. 11, four wireless links are established. The four wireless links are established between the wireless communication device 40a and the wireless communication device 50a, between the wireless communication device 40b and the wireless communication device 50b, between the wireless communication device 40c and the wireless communication device 50c, and between the wireless communication device 40d and the wireless communication device 50d, respectively.

The transmission control device 13 and the wireless communication device 40 can communicate with each other via a communication line network. The transmission control device 13 and the device 60 can communicate with each other via a communication line network. The reception control device 23 and the wireless communication device 50 can communicate with each other via a communication line network. The reception control device 23 and the device 70 can communicate with each other via a communication line network. The communication line network is a local area network, for example. However, the communication line network can use a known network without being particularly limited. The communication line network may be a personal area network, a CAN, a metropolitan area network, a wide area network, or a GAN. The communication line network may be an external network such as the Internet.

The communication may be performed between the transmission control device 13 and the wireless communication device 40, between the transmission control device 13 and the device 60, between the reception control device 23 and the wireless communication device 50, and between the reception control device 23 and the device 70 via an interface instead of the communication line network. The interface is, for example, an RS-232 or an RS-422, an RS-485, a USB, and an IEEE 1394.

The transmission control device 13 includes an information processor and a communication interface which are not shown. The information processor includes a central processing unit and a storage unit which are not shown. The storage unit in the information processor is a memory and a hard disk drive. The transmission control device 13 is configured to realize a function to be described below by executing a program stored in the storage unit with the central processing unit, for example. The transmission control device 13 may be an IP core. The IP core is, for example, an FPGA, an IC, and an LSI.

The reception control device 23 includes an information processor and a communication interface which are not shown. The information processor includes a central processing unit and a storage unit which are not shown. The storage unit in the information processor is a memory and a hard disk drive. The reception control device 23 is configured to realize a function to be described below by executing a program stored in the storage unit with the central processing unit, for example. The reception control device 23 may be an IP core.

The transmission control device 13 includes a composite signal generation unit 131, a multipath control unit 132, and a reception signal analysis unit 133. The transmission control device 13 includes an information processor and a communication interface which are not shown. The information processor includes a central processing unit, a transceiver, and a storage unit. Operations of the composite signal generation unit 131, the multipath control unit 132, and the reception signal analysis unit 133 will be described below when the central processing unit, the transceiver, and the storage unit operate in the transmission control device 13 in cooperation with one another.

The composite signal generation unit 131 can accumulate a modulation signal sent from the device 60. The composite signal generation unit 131 further selects K modulation signals from the accumulated modulation signals and superposes the selected K modulation signals. In the fifth example embodiment, at least one modulation signal is selected from the K modulation signals and superposed.

In the fifth example embodiment, a predetermined number K can be arbitrarily set in the transmission control device 13. However, the predetermined number K can be set in the device 60, the device 70, the reception control device 23, the wireless communication device 40, or the wireless communication device 50. When the device 60, the device 70, the reception control device 23, the wireless communication device 40, or the wireless communication device 50 sets the predetermined number K, the device for setting the predetermined number K notifies the transmission control device 13 of information related to the predetermined number K. The transmission control device 13 sets the predetermined number K according to the notified information.

In the wireless communication system 5, a signal used for communication is a modulation signal. When the signal is a modulation signal, characteristics of the wireless network 30 to be measured are, for example, a roundtrip transmission delay, a bit error rate, a block error rate, a transmission band, a modulation method, and a coding rate of the modulation signal between the transmission control device 13 and the reception control device 23. Accordingly, the multipath control unit 132 preferably selects a wireless link based on at least one of the roundtrip transmission delay, the bit error rate, the block error rate, the transmission band, the modulation method, and the coding rate.

The modulation signal (hereinafter, referred to as a superposed modulation signal) superposed by the composite signal generation unit 131 is sent to the multipath control unit 132. The superposition process is repeated until an ACK notification is received from the reception signal analysis unit 133 to be descried below. When the composite signal generation unit 131 receives the ACK notification from the reception signal analysis unit 133, the superposition process is ended, and the K modulation signals targeted for the superposition process are discarded.

The multipath control unit 132 establishes a plurality of wireless links having different frequencies in the wireless network 30 to enable communication between the transmission control device 13 and the reception control device 23. The multipath control unit 132 selects at least one wireless link from the plurality of wireless links having different frequencies established in the wireless network 30, and transmits the superposed modulation signal sent from the composite signal generation unit 131 to the reception control device 23. The superposed modulation signal transmitted from the multipath control unit 132 is transmitted from the wireless communication device 40 on the selected wireless link. The transmitted superposed modulation signal is received by the wireless communication device 50 on the same wireless link, and arrives at a multipath control unit 231.

The multipath control unit 132 receives an ACK notification signal from each of the plurality of wireless links having different frequencies established between the transmission control device 13 and the reception control device 23. The ACK notification number received by the multipath control unit 132 is generated by an ACK generation unit 233 provided in the reception control device 23. The received ACK notification signal is transmitted to the reception signal analysis unit 133 in the reception control device 23. When the ACK notification signal arrives, the reception signal analysis unit 133 notifies the composite signal generation unit 131 of ACK.

The reception control device 23 includes a multipath control unit 231, a signal recovery unit 232, and an ACK generation unit 233. Operations of the multipath control unit 231, the signal recovery unit 232, and the ACK generation unit 233 will be described below when the central processing unit, the transceiver, and the storage unit provided in the reception control device 23 operate in cooperation with one another.

The multipath control unit 231 establishes a plurality of wireless links having different frequencies in the wireless network 30 to enable communication between the transmission control device 13 and the reception control device 23. The multipath control unit 231 receives the superposed modulation signal from each of the plurality of wireless links having different frequencies established in the wireless network 30. The superposed modulation signal received by the multipath control unit 231 is transmitted to the signal recovery unit 232.

The multipath control unit 231 selects at least one wireless link from the plurality of wireless links having different frequencies established between the transmission control device 13 and the reception control device 23, and transmits an ACK notification signal to the transmission control device 13. The ACK notification number transmitted by the multipath control unit 231 is generated by the ACK generation unit 233. The ACK notification signal transmitted from the multipath control unit 231 is transmitted from the wireless communication device 50 on the selected wireless link. The transmitted ACK packet is received by the wireless communication device 40 on the same wireless link, and arrives at the transmission control device 13.

The signal recovery unit 232 accumulates the superposed modulation signals transmitted by the multipath control unit 231. The signal recovery unit 232 decodes the accumulated superposed modulation signals into K packets with an interference canceler. A recovery method of the signal in the signal recovery unit 212 is not particularly limited. The signal recovery unit 232 decodes K packets from the accumulated superimposed modulation signals, using Gaussian elimination, for example. With the Gaussian elimination, K modulation signals can be recovered when there are at least K superposed modulation signals. Therefore, the signal recovery unit 232 needs to accumulate at least K superposed modulation signals transmitted by the multipath control unit 231.

The recovered K packets are sent to the device 70. The signal recovery unit 232 notifies the ACK generation unit 213 that the decoding of the packets is completed. Upon receiving the notification that the decoding of K packets is completed, the ACK generation unit 233 generates an ACK packet. The generated ACK packet is transmitted from the multipath control unit 231 to the transmission control device 13.

### <Description of Operation>

An operation of the wireless communication system according to the fifth example embodiment will be described in detail below. The composite signal generation unit 131 in the transmission control device 13 selects K modulation signals from the accumulated modulation signals, and superposes the selected K modulation signals to generate a superposed modulation signal. The composite signal generation unit 131 performs an operation of superposing the modulation signals at the time of generation of the superposed modulation signal, instead of the operation of encoding the packets when the composite signal generation unit 111 in the transmission control device 11 generates the coded packet.

The multipath control unit 132 in the transmission control device 13 selects at least one wireless link from the plurality of wireless links having different frequencies established between the transmission control device 13 and the reception control device 23. Then, the multiple modulation signal sent from the composite signal generation unit 131 is transmitted to the reception control device 23. The multipath control unit 132 in the transmission control device 13 performs an operation of transmitting the multiple modulation signal when transmitting the multiple modulation signal to the reception control device 23, instead of the operation of transmitting the coded packet performed by the multipath control unit 112 of the transmission control device 11.

The signal recovery unit 232 in the reception control device 23 recovers the superposed modulation signals transmitted by the multipath control unit 231 into K modulation signals with the interference canceler. The signal recovery unit 232 performs an operation of decoding the superposed modulation signal when recovering into K modulation signals, instead of the operation of decoding the coded packet and decoding into the predetermined number K of packets performed by the signal recovery unit 212 in the reception control device 21.

The multipath control unit 231 in the reception control device 23 selects at least one wireless link from the plurality of wireless links having different frequencies established between the transmission control device 13 and the reception control device 23. Then, the multipath control unit transmits the ACK notification signal generated by the ACK generation unit 233 to the transmission control device 13. The multipath control unit 231 performs an operation of transmitting the ACK notification signal, instead of the operation of transmitting the ACK packet performed by the multipath control unit 211 in the reception control device 21.

As described above, according to the fifth example embodiment of the present invention, it is possible to reduce the number of round trips and to realize low delay without requiring a large-capacity buffer.

### Modifications of Fifth Example Embodiment

For example, in the fifth example embodiment, when a plurality of modulation signals are superposed, an amplitude, a phase, or a power spectrum density of each of the modulation signals may be changed. When the amplitude, the phase, or the power spectrum density of each of the modulation signals is changed, information related to the changed amplitude, phase, or power spectrum density is notified as control information.

Further, an interference cancellation used by the signal recovery unit 232 is not particularly limited. The interference cancellation is, for example, a parallel interference cancellation (PIC). The interference cancellation may be a successive interference cancellation (SIC) or an interference rejection combining (IRC).

The fifth example embodiment can also be implemented in the configurations of the second to fourth example embodiments including the modification.

According to the invention related to the example embodiments described above, it is possible to provide a wireless communication system, a wireless communication method, a transmission control device, a reception control device, a transmission control program, and a reception control program capable of reducing the number of round trips and to realize a low delay without requiring a large-capacity buffer.

The present invention is not limited to the above-described example embodiments, and can be appropriately modified without departing from the gist. The above-described example embodiments may be implemented independently or in combination as appropriate.

Some or all of the above-described example embodiments may also be described as Supplementary notes to be described below, but are not limited thereto.

### (Supplementary Note A1)

1. A wireless communication system comprising a transmission control device and a reception control device configured to communicate with each other via at least one wireless link established in a wireless network,

the transmission control device including a composite signal generation unit configured to select at least one signal from a predetermined number of signals to generate a composite signal, and a multipath control unit configured to transmit the composite signal via the at least one wireless link,

the reception control device including a multipath control unit configured to receive the composite signal from the at least one wireless link, and a signal recovery unit configured to accumulate the received composite signal and to recover the predetermined number of signals from the predetermined number or more of the composite signals,

the predetermined number being 1 or more.

(Supplementary note A2)

The wireless communication system according to note A1, wherein

a plurality of wireless links having different frequencies are established in the wireless network,

the multipath control unit of the transmission control device selects at least one wireless link from the plurality of wireless links and transmits the composite signal, and

the multipath control unit of the reception control device receives the composite signal from each of the plurality of wireless links.

(Supplementary note A3)

The wireless communication system according to note A2, further comprising a network environment measurement unit configured to measure a status of the wireless network,

wherein the multipath control unit of the transmission control device selects at least one wireless link from the plurality of wireless links, using a communication characteristic to be guaranteed with respect to a communication characteristic required for a signal to reach the reception control device from the transmission control device and the status of the wireless network measured by the network environment measurement unit.

(Supplementary note A4)

The wireless communication system according to note A3, wherein the composite signal generation unit of the transmission control device determines the predetermined number based on the status of the wireless network measured by the network environment measurement unit.

(Supplementary note A5)

The wireless communication system according to note A3 or A4, wherein

the signal is a packet, and

the status of the wireless network measured by the network environment measurement unit is at least one selected from the group including a forward transmission delay, a packet loss rate, a transmission band, and a packet size of the packet between the transmission control device and the reception control device.

(Supplementary note A6)
The wireless communication system according to any one of notes A1 to A5, wherein

the signal is a packet, and

the composite signal generation unit selects at least one packet from the predetermined number of packets to generate a coded packet obtained by an exclusive OR (XOR).

(Supplementary note A7)

The wireless communication system according to note A3 or A4, wherein the communication characteristic is at least one selected from the group including a roundtrip transmission delay, a bit error rate, a block error rate, a transmission band, a modulation method, and a coding rate of a modulation signal between the transmission control device and the reception control device.

### (Supplementary Note A8)

The wireless communication system according to any one of notes 1 to A4 and A7, wherein

the signal is a modulation signal, and

the composite signal generation unit selects at least one modulation signal from the predetermined number of modulation signals and applies different transmission power to each of the selected modulation signals to multiplex each of the selected modulation signals.

### (Supplementary Note B1)

A transmission control device comprising:

a composite signal generation unit configured to select at least one signal from a predetermined number of signals to generate a composite signal; and

a multipath control unit configured to transmit the composite signal via at least one wireless link established in a wireless network.

(Supplementary note B2)
The transmission control device according to note B1, wherein the multipath control unit selects at least one wireless link from a plurality of wireless links having different frequencies established in the wireless network to transmit the composite signal.

### (Supplementary Note C1)

A reception control device comprising:

a multipath control unit configured to receive a composite signal from at least one wireless link established in a wireless network; and

a signal recovery unit configured to accumulate the received composite signal and to recover the predetermined number of signals from the predetermined number or more of the composite signals,

the predetermined number being 1 or more.

### (Supplementary Note C2)

The reception control device according to note C1, wherein the multipath control unit receives the composite signal from each of a plurality of wireless links having different frequencies established in the wireless network.

(Supplementary note D1)
A wireless communication system comprising:

two transmission/reception control devices configured to communicate with each other via at least one wireless link established in a wireless network,

each of the two transmission/reception control devices including:

a composite signal generation unit configured to select at least one signal from a predetermined number of signals to generate a composite signal;

a multipath control unit configured to transmit the composite signal via the at least one wireless link and to receive a composite signal transmitted from a communication partner via the at least one wireless link; and

a signal recovery unit configured to accumulate the received composite signal and to recover the predetermined number of signals from the predetermined number or more of the composite signals,

the predetermined number being 1 or more.

### (Supplementary Note D2)

The wireless communication system according to note D1, wherein

a plurality of wireless links having different frequencies are established in the wireless network, and

the multipath control unit selects at least one wireless link from the plurality of wireless links to transmit the composite signal, and receives the composite signal from each of the plurality of wireless links.

(Supplementary note E1)
A transmission/reception control device comprising:

a composite signal generation unit configured to select at least one signal from a predetermined number of signals to generate a composite signal;

a multipath control unit configured to transmit the composite signal via at least one wireless link established in a wireless network and to receive a composite signal transmitted from a communication partner via the at least one wireless link; and

a signal recovery unit configured to accumulate the received composite signal and to recover the predetermined number of signals from the predetermined number or more of the composite signals,

the predetermined number being 1 or more.

### (Supplementary Note E2)

The transmission/reception control device according to note E1, wherein the multipath control unit selects at least one wireless link from a plurality of wireless links having different frequencies established in the wireless network to transmit the composite signal, and receives the composite signal transmitted from the communication partner via each of the plurality of wireless links.

### (Supplementary Note F1)

A wireless communication method comprising:

a step of selecting at least one signal from a predetermined number of signals to generate a composite signal in a composite signal generation unit of a transmission control device;

a step of transmitting the composite signal to a reception control device via at least one wireless link established in a wireless network in a multipath control unit of the transmission control device;

a step of receiving the composite signal from the at least one wireless link in a multipath control unit of the reception control device; and

a step of recovering the predetermined number of signals from the received composite signal in a signal recovery unit of the reception control device.

### (Supplementary Note G1)

A transmission control method comprising:

a step of selecting at least one signal from a predetermined number of signals to generate a composite signal; and

a step of transmitting the composite signal via at least one wireless link established in a wireless network such that a reception control device is capable of receiving the composite signal.

### (Supplementary Note H1)

A reception control method comprising:

a step of receiving a composite signal transmitted from a transmission control device via at least one wireless link established in a wireless network; and

a step of recovering a predetermined number of signals from the received composite signal.

### (Supplementary Note I1)

A wireless communication method comprising:

a step of selecting at least one signal from a predetermined number of signals to generate a composite signal in a composite signal generation unit of one transmission/reception control device of two transmission/reception control devices;

a step of transmitting the composite signal to the other transmission/reception control device via at least one wireless link established in a wireless network in a multipath control unit of the one transmission/reception control device;

a step of receiving the composite signal from the at least one wireless link in a multipath control unit of the other transmission/reception control device; and

a step of recovering the predetermined number of signals from the received composite signal in a signal recovery unit of the other transmission/reception control device.

### (Supplementary Note J1)

A non-transitory computer-readable medium for storing a transmission control program that causes a computer to execute:

a process of selecting at least one signal from a predetermined number of signals to generate a composite signal; and

a process of transmitting the composite signal via at least one wireless link established in a wireless network such that a reception control device is capable of receiving the composite signal.

### (Supplementary Note K1)

A non-transitory computer-readable medium for storing a reception control program that causes a computer to execute:

a process of receiving a composite signal transmitted from a transmission control device via at least one wireless link established in a wireless network; and

a process of recovering a predetermined number of signals from the received composite signal.

### (Supplementary Note L1)

A non-transitory computer-readable medium for storing a transmission/reception control program that causes a computer to execute:

a process of selecting at least one signal from a predetermined number of signals to generate a composite signal;

a process of transmitting the composite signal via at least one wireless link established in a wireless network such that a communication partner is capable of receiving the composite signal;

a process of receiving a composite signal transmitted from the communication partner from each of a plurality of wireless links having different frequencies established in a wireless network; and

a process of recovering the predetermined number of signals from the received composite signal.

Although the application invention has been described above with reference to the example embodiments, the application invention is not limited to the above-described example embodiments. The configurations and details of the application invention can be variously changed within the scope of the invention to be capable of being understood by those skilled in the art.

This application is based upon and claims the benefit of priority from Japanese Patent Application No. 2019-063951, filed on Mar. 28, 2019, the entire contents of which are incorporated herein by reference.

### REFERENCE SIGNS LIST

1, 2, 3, 4, 5 WIRELESS COMMUNICATION SYSTEM
10, 11, 12, 13 TRANSMISSION CONTROL DEVICE
20, 21, 22, 23 RECEPTION CONTROL DEVICE
30 WIRELESS NETWORK
40, 40a, 40b, 40c, 40d WIRELESS COMMUNICATION DEVICE
50, 50a, 50b, 50c, 50d WIRELESS COMMUNICATION DEVICE
60, 70 DEVICE
80, 80a, 80b TRANSMISSION/RECEPTION CONTROL DEVICE
101, 111, 121, 131, 801 COMPOSITE SIGNAL GENERATION UNIT
102, 112, 122, 132, 201, 211, 221, 231, 802 MULTIPATH CONTROL UNIT
113, 123, 133, 803 RECEPTION SIGNAL ANALYSIS UNIT
114, 214, 806 WIRELESS COMMUNICATION UNIT
124 NETWORK ENVIRONMENT MEASUREMENT UNIT
125 GUARANTEED VALUE INPUT UNIT
126 PARAMETER CALCULATION UNIT
202, 212, 222, 232, 804 SIGNAL RECOVERY UNIT
213, 223, 233, 805 ACK GENERATION UNIT
601 SIGNAL GENERATION UNIT
701 SIGNAL RECEPTION UNIT
681, 781 SIGNAL OPERATION UNIT

What is claimed is:

1. A wireless communication system comprising a transmission control device and a reception control device configured to communicate with each other via at least one wireless link established in a wireless network,
the transmission control device including a composite signal generation unit configured to select at least one signal from a predetermined number of signals to generate a composite signal, and a multipath control unit configured to transmit the composite signal via the at least one wireless link,
the reception control device including a multipath control unit configured to receive the composite signal from the at least one wireless link, and a signal recovery unit configured to accumulate the received composite signal and to recover the predetermined number of signals from the predetermined number or more of the composite signals,
the predetermined number being 1 or more.

2. The wireless communication system according to claim 1, wherein
a plurality of wireless links having different frequencies are established in the wireless network,
the multipath control unit of the transmission control device selects at least one wireless link from the plurality of wireless links and transmits the composite signal, and
the multipath control unit of the reception control device receives the composite signal from each of the plurality of wireless links.

3. The wireless communication system according to claim 2, further comprising a network environment measurement unit configured to measure a status of the wireless network,
wherein the multipath control unit of the transmission control device selects at least one wireless link from the plurality of wireless links, using a communication characteristic to be guaranteed with respect to a delay time required for a signal to reach the reception control device from the transmission control device and the status of the wireless network measured by the network environment measurement unit.

4. The wireless communication system according to claim 3, wherein the composite signal generation unit of the transmission control device determines the predetermined number based on the status of the wireless network measured by the network environment measurement unit.

5. The wireless communication system according to claim 3, wherein
the signal is a packet, and
the status of the wireless network measured by the network environment measurement unit is at least one selected from the group including a forward transmission delay, a packet loss rate, a transmission band, and a packet size of the packet between the transmission control device and the reception control device.

6. The wireless communication system according to claim 1, wherein
the signal is a packet, and
the composite signal generation unit selects at least one packet from the predetermined number of packets to generate a coded packet obtained by an exclusive OR (XOR).

7. The wireless communication system according to claim 3, wherein the communication characteristic is at least one selected from the group including a roundtrip transmission delay, a bit error rate, a block error rate, a transmission band, a modulation method, and a coding rate of a modulation signal between the transmission control device and the reception control device.

8. The wireless communication system according to claim 1, wherein
the signal is a modulation signal, and
the composite signal generation unit selects at least one modulation signal from the predetermined number of modulation signals and applies different transmission power to each of the selected modulation signals to multiplex each of the selected modulation signals.

9.-16. (canceled)

17. A wireless communication method comprising:
a step of selecting at least one signal from a predetermined number of signals to generate a composite signal in a composite signal generation unit of a transmission control device;
a step of transmitting the composite signal to a reception control device via at least one wireless link established in a wireless network in a multipath control unit of the transmission control device;
a step of receiving the composite signal from the at least one wireless link in a multipath control unit of the reception control device; and
a step of recovering the predetermined number of signals from the received composite signal in a signal recovery unit of the reception control device.

18.-22. (canceled)

23. A non-transitory computer-readable medium for storing a transmission/reception control program that causes a computer to execute:
a process of selecting at least one signal from a predetermined number of signals to generate a composite signal;
a process of transmitting the composite signal via at least one wireless link established in a wireless network such that a communication partner is capable of receiving the composite signal;
a process of receiving a composite signal transmitted from the communication partner from each of a plurality of wireless links having different frequencies established in the wireless network; and
a process of recovering the predetermined number of signals from the received composite signal.
